(19) United States
(12) Patent Application Publication
(10) Pub. No.: US 2005/0095401 A1
(43) Pub. Date: May 5, 2005

(54) Image recording material and depression-and-protrusion forming method

(75) Inventors: Yoshio Tani, Shizuoka (JP); Shigehisa Tamagawa, Shizuoka (JP); Shinji Kato, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/978,455

(22) Filed: Nov. 2, 2004

(30) Foreign Application Priority Data
Nov. 4, 2003 (JP) 2003-374007
Aug. 26, 2004 (JP) 2004-247488

(51) Int. Cl. B32B 3/00

(52) U.S. Cl. 428/156

(57) ABSTRACT

An image recording material, includes: a support; and an image recording layer disposed on the support, and having a depression-and-protrusion at least on a part of an image face of the image recording material after an image recording. The depression-and-protrusion defines a slope inclined from the image face. The depression-and-protrusion of the image face has a ten point height of roughness profile Rz in a range from 5 μm to 25 μm and has an average depression-and-protrusion space Sm defined in JIS B0601-1994 in a range from 100 μm to 1000 μm.

### BACKGROUND OF THE INVENTION

1. Field of the Invention

The present invention relates to a high-quality image recording material which has a calm image quality in a silk tone having as high grade as that of a silver salt photographic print and which can go unremarkable even with a fingerprint adhered to an image face after an image recording. The present invention also relates to a depression-and-protrusion forming method using the above high-quality image recording material.

2. Description of the Related Art

Conventionally, methods of improving image quality of various image recording materials were proposed, including those imparting surface properties such as gloss face, mat face, silk tone, luster, and the like.

For example, Japanese Patent No. 3185254 discloses a sublimational heat transfer receiving sheet having the following structure: a support is made of raw paper having both faces formed with respective polyolefin resin layers. A receiving layer is formed on one of the polyolefine resin layers. The polyolefin resin layer for the receiving layer is subjected to an operation such as those for forming mat face, silk tone face, fine particle face and the like. The polyolefine resin layer has a surface having ten point height of roughness profile Rz in a range from 3 μm to 10 μm. Japanese Patent No. 3185254, however, relates to the sublimational heat transfer receiving sheet, free from description of surface roughness and average depression-and-protrusion space on the image face after image recording. Therefore, the effect on the silk tone and the fingerprint adhesion is unclear.

Japanese Patent Application Laid-Open UP-A) No. 2000-10328 discloses an electrophotographic transferred paper having a support and a transferred layer which is disposed at least on one face of the support. The surface of the transferred layer has ten point height of roughness profile Rz in a range from 2.5 μm to 10.5 μm. JP-A No. 2000-10328, however, has an object of imparting gloss to the image face after the image recording, and is free from description of forming depression-and-protrusion on the image face after the image recording, and description of average depression-and-protrusion space. Therefore, the effect on the silk tone and the fingerprint adhesion is unclear.

JP-A No. 2-162382 discloses a method of forming roughness by using a mat fixing belt (Rz=0.3 μm to 10 μm) on an electrophotographic developing face. JP-A No. 2001-125411 discloses a method of forming roughness by using a mat fixing belt (Rz=0.01 μm to 500 μm) on an electrophotographic developing face. JP-A No. 2000-66466 discloses a depression-and-protrusion forming method where an electrophotographic receiving sheet having at least one toner image-receiving layer is heated-pressed after forming-fixing a toner image, to thereby stamp the shape of the heated-pressed section on at least one of a surface, a backface and an image recording face of the electrophotographic receiving sheet. Each of JP-A No. 2-162382, JP-A No. 2001-125411 and JP-A No. 2000-66466 is free from description of the surface roughness and average depression-and-protrusion space on the image face after the image recording, does not aim for bringing about a calm image quality in a silk tone having high grade, failing to prevent decreased image quality with a fingerprint adhered to the image face after the image recording.

The above conventional image recording materials (especially, the electrophotographic receiving sheet) are free from any method of efficiently forming a calm image quality in a silk tone having as high grade as that of a silver salt photographic print, leaving a need for a method of preventing image-quality decrease with the fingerprint adhered to the image face after the image recording.

Objects and Advantages

It is an object of the present invention to provide a high-quality image recording material which has a calm image quality in a silk tone having as high grade as that of a silver salt photographic print and which can go unremarkable even with a fingerprint adhered to an image face after an image recording. It is another object of the present invention to provide a depression-and-protrusion forming method using the above high-quality image recording material. For the above objects, at least a part of the image face is to have a specific roughness profile.

### SUMMARY OF THE INVENTION

The image recording material of the present invention comprises a support and an image recording layer disposed on the support. The image recording layer has at least partly a depression-and-protrusion defining a slope inclined from the image face on an image face after an image recording. The image face has a ten point height of roughness profile Rz in a range from 5 μm to 25 μm and the depression-and-protrusion has an average depression-and-protrusion space Sm in a range from 100 μm to 1000 μm. Of the present invention, forming a predetermined roughness profile of the image face after the image recording i) brings about a calm image quality in a silk tone having as high grade as that of a silver salt photographic print and ii) allows the image recording material to go unremarkable even with a fingerprint adhered to the image face after the image recording. Moreover, roughing the image face can improve traveling property and adhesion resistance in storage, which is preferable for a large amount of printing.

The depression-and-protrusion forming method of the present invention, according to its first aspect comprises: heating at least a part of an image face of an image recording material after an image recording; and transferring to the thus heated image face a depression-and-protrusion by pressing to the heated image face a molding member having a surface formed with the depression-and-protrusion, the depression-and-protrusion defining a slope inclined from the image face, wherein the depression-and-protrusion has a ten point height of roughness profile Rz in a range from 5 μm to 25 μm and has an average depression-and-protrusion space Sm defined in JIS B0601-1994 in a range from 100 μm to 1000 μm.

The depression-and-protrusion forming method of the present invention, according to its second aspect, comprises: disposing an image recording layer on a support, the support's side to be formed with the image recording layer having a first depression-and-protrusion which has a ten point height of roughness profile Rz in a range from 5 μm to 25 μm and has an average depression-and-protrusion space Sm in a range from 100 μm to 1000 μm; and recording an image on the image recording layer, to thereby form on an image face of the image recording layer a second depression-and-protrusion defining a slope inclined from the image face, wherein the second depression-and-protrusion of the image face has a ten point height of roughness profile Rz in a range from 5 μm to 25 μm and has an average depression-and-protrusion space Sm defined in JIS B0601-1994 in a range from 100 μm to 1000 μm.

With the depression-and-protrusion forming methods according to its first aspect and the second aspect, the image face of various image recording materials can be treated with ease, thus effectively forming roughness profile.

### BRIEF DESCRIPTION OF THE DRAWINGS

FIG. 1A to FIG. E show schematic cross sectional views of depression-and-protrusion formed on an image face of an image recording material after image recording, according to an embodiment.

FIG. 2 is a schematic of an example of an image-forming apparatus used for a depression-and-protrusion forming method used in the examples.

FIG. 3 is a schematic of an image surface smoothing-fixing apparatus, according to an embodiment.

### DESCRIPTION OF THE PREFERRED EMBODIMENTS

(Image Recording Material)

An image recording material of the present invention has a support, and at least an image recording layer disposed on the support. Moreover, when necessary, the image recording material of the present invention has other layers such as a back layer, an intermediate layer, an undercoat layer, a cushion layer, a reflecting layer, a tint adjusting layer, a preservability improving layer, an adhesive preventive layer, an anti curl layer, a smoothing layer and the like. Each of the above layers may be alone or have a laminated structure.

The image recording material has, at least partly (preferably, in most part; more preferably, substantially entirely), a depression-and-protrusion defining a slope inclined from the image face on an image face after an image recording. The image face has ten point height of roughness profile Rz defined in JIS B0601-1994 in a range from 5 μm to 25 μm and an average depression-and-protrusion space Sm defined in JIS B0601-1994 is in a range from 100 μm to 1000 μm.

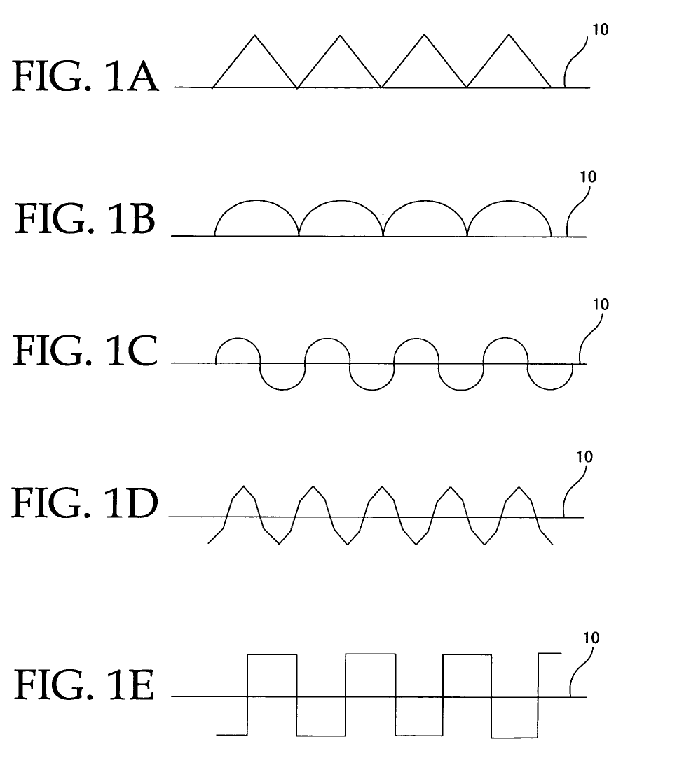

The above depression-and-protrusion is a profile defining a slope inclined from the image face (a reference face) in at least one of an upward direction and a downward direction, that is, independent and a series of mountains each having peak-and-valley, examples thereof including cones (pyramids) such as a triangular cone, a rectangular cone and the like (refer to FIG. 1A) protruding from an image face 10; a hemisphere (refer to FIG. 1B) protruding from the image face 10; a combination of an upper hemisphere and a lower hemisphere (refer to FIG. 1C) protruding from the image face 10; a combination of an upper spindle and a lower spindle (refer to FIG. 1D) protruding from the image face 10; and the like, excluding those shaped into a digital waveform free from peak-and-valley (refer to FIG. 1E).

The ten point height of roughness profile Rz is preferably in a range from 5 μm to 25 μm, more preferably in a range from 5 μm to 20 μm.

The ten point height of roughness profile Rz less than 5 μm may fail to form the calm image quality in the silk tone and may increase visibility of the fingerprint, while the ten point height of roughness profile Rz more than 25 μm may roughen the image thus degrading the image and deteriorating the traveling property.

The average depression-and-protrusion space Sm is preferably in a range from 100 μm to 1000 μm, more preferably in a range from 150 μm to 800 μm.

The average depression-and-protrusion space Sm less than 100 μm may fail to form the calm image quality in the silk tone and may increase visibility of the fingerprint, while the average depression-and-protrusion space Sm more than 1000 μm may roughen the image.

Herein, the ten point height of roughness profile Rz and the average depression-and-protrusion space Sm of the image face are pursuant to those specified in JIS B0601-1994.

According to JIS B0601-1994, the ten point height of roughness profile Rz is defined in the following manner: Within a reference length, sample five peaks (Yₚ₁, Yₚ₂, Yₚ₃, Yₚ₄, Yₚ₅) in the order of height and five valleys (Yᵥ₁, Yᵥ₂, Yᵥ₃, Yᵥ₄, Yᵥ₅) in the order of depth, then calculate Rz according to the following expression: Rz=(|Yₚ₁+Yₚ₂+Yₚ₃+Yₚ₄+Yₚ₅|+|Yᵥ₁+Yᵥ₂+Yᵥ₃+Yᵥ₄+Yᵥ₅|)/5.

According to JIS B0601-1994, the average depression-and-protrusion space Sm is an average of periodical spaces (Sm₁, Sm₂, . . . Smₙ) each defined by two intersection points (having therebetween another intersection point) defined by a roughness curve and a reference line. In other words, Sm is given by the follwoing expression.

$$Sm = \frac{1}{n} {\sum }_{i = 1}^{n} Smi$$

The ten point height of roughness profile Rz and the average depression-and-protrusion space Sm of the image face can be measured with a surface profile measurement machine pursuant to JIS B0601-1994.

A specific profile of the depression-and-protrusion formed on the image face of the image recording material may be formed efficiently by a depression-and-protrusion forming method under the preset invention, to be described afterward.

-Support-

The support is not specifically limited, and can be suitably selected according to the object, examples thereof including one having i) raw paper and ii) a polyolefine resin layer on the raw paper's face to be formed with the image recording layer. More preferably, the polyolefin resin layers are to be disposed on both faces of the raw paper. When necessary, the support is formed with other layers.

-Raw Paper-

The above raw paper is not particularly limited, and can be suitably selected according to the object. Specifically, the raw paper can be preferred to be woodfree paper (high-quality paper) described on page 223 to page 224 of Society of Photographic Science and Technology of Japan “Fundamentals of Photography (shashin kougaku no kiso)—Silver Salt Photograph—” published by Corona (Showa 54 [1979]).

As long as being a known material used for the support, the raw paper is not particularly limited, and can be suitably selected according to the object. Examples of the raw paper include natural pulps such as needle-leaf pulp, broad-leaf pulp and the like, a mixture of the above natural pulp(s) with a synthetic pulp(s), and the like.

The pulp usable for a raw material of the raw paper is preferred to be the broad-leaf kraft pulp (LBKP), from the viewpoint of simultaneously keeping surface smoothness, rigidity and dimensional stability (curling property) and the like of the raw paper in a good balance and simultaneously improving them to a sufficient level. The needle-leaf kraft pulp (LBKP), the broad-leaf sulfite pulp (LBSP) and the like are, however, also usable.

A beater, a refiner and the like can be used for beating the pulp.

For controlling paper contraction in a papermaking operation, the Canadian standard water filtration of the pulp is preferably in a range from 200 ml C. S. F. to 440 ml C. S. F., more preferably in a range from 250 ml C. S. F. to 380 ml C. S. F.

When necessary, various types of additives can be added to a pulp slurry (hereinafter referred to as “pulp paper material” as the case may be) which can be obtained after beating the pulp. Examples of the additives include filling material, dry paper reinforcer, sizing agent, wet paper reinforcer, fixing agent, pH regulator, and other agents.

Examples of the filling materials include calcium carbonate, clay, kaolin, white earth, talc, titanium oxide, diatomaceous earth, barium sulfate, aluminum hydroxide, magnesium hydroxide and the like.

Examples of the dry paper reinforcers include cationic starch, cationic polyacrylamide, anionic polyacrylamide, amphoteric polyacrylamide, carboxy-modified polyvinyl alcohol and the like.

Examples of the sizing agents include compounds containing high fatty acid. Specific examples thereof include rosin derivatives such as high fatty acid salts, rosin, maleic rosin and the like; paraffin wax; alkyl ketene dimer; alkenyl succinic anhydride (ASA); epoxy fatty acid amide; and the like.

Examples of the wet paper reinforcers include polyamine polyamide epichlorohydrin, melamine resin, urea resin, epoxy polyamide resin and the like.

Examples of the fixing agents include polyfunctional metal salts such as aluminum sulfate, aluminum chloride, and the like; cationic polymers such as cationic starch; and the like.

Examples of the pH regulators include caustic soda, sodium carbonate and the like.

Examples of the other agents include defoaming agents, dyes, slime control agents, fluorescent brightening agents and the like.

Moreover, softeners and the like can also be added when necessary. For the softeners, ones which are disclosed on pp. 554-555 of Paper and Paper Treatment Manual (Shiyaku Time Co., Ltd.) (1980) and the like can be used, for example.

Each of the above additives and the like can be used alone or in combination of two or more. The amount of each of the additives and the like into the pulp paper material is not particularly limited, and can be suitably selected according to the object, 0.1% by mass to 1.0% by mass being preferred ordinarily.

Moreover, the pulp paper material which is the pulp slurry to which the various types of additives are added when necessary is to be machined by using paper-making machines such as a manual paper-making machine, a Fourdrinier (long-net) paper-making machine, a round-net paper-making machine, a twin-wire machine, a combination machine, and thereafter is dried for preparing the raw paper. When necessary, either before or after the drying, a surface sizing treatment can be carried out.

The treatment liquid used for the surface sizing treatment is not specifically limited, and can be suitably selected according to the object, examples thereof including water-soluble high molecular compound, waterproof substance, pigment, dye, fluorescent brightening agent, and the like.

Examples of the water-soluble high molecular compounds include cationic starch, polyvinyl alcohol, carboxy-modified polyvinyl alcohol, carboxymethyl cellulose, hydroxyethyl cellulose, cellulose sulfate, gelatin, casein, sodium polyacrylate, sodium salt of styrene-maleic acid anhydride copolymer, sodium polystyrene sulfonate, and the like.

Examples of the waterproof materials include latex emulsions such as styrene-butadiene copolymer, ethylene-vinyl acetate copolymer, polyethylene, vinylidene chloride copolymer and the like; polyamide polyamine epichlorohydrin; and the like.

Examples of the pigments include calcium carbonate, clay, kaolin, talc, barium sulfate, titanium oxide, and the like.

For the above-mentioned raw paper, to improve the rigidity (stiffness) and dimensional stability (curling property), it is preferred that the ratio (Ea/Eb) of the longitudinal Young's modulus (Ea) to the lateral Young's modulus (Eb) is within a range from 1.5 to 2.0. When the ratio (Ea/Eb) is less than 1.5 or more than 2.0, the rigidity (stiffness) and dimensional stability (curling property) of the image recording material support tend to deteriorate, and may cause inconveniences to traveling property during transportation.

It has been found that, in general, the “rigidity (stiffness)” of the paper differs based on differences in the way the paper is beaten, and the elasticity modulus of paper from paper-making after beating can be used as an important indication of the “rigidity (stiffness)” of the paper. The elasticity modulus of the paper can be calculated from the following equation by using the relation of the density and the dynamic modulus which shows the physical properties of a viscoelastic object, and by measuring the velocity of sound propagation in the paper using an ultrasonic oscillator.
E=pc²(1−n²)
where “E” represents dynamic elasticity modulus; “p” represents density; “c” represents the velocity of sound in paper; and

“n” represents Poisson's ratio.

As n=0.2 or so in a case of ordinary paper, there is not much difference in the calculation, even when the calculation is performed by the following equation:
E=pc²

Accordingly, when the density of the paper and the acoustic velocity can be measured, the elasticity modulus can easily be calculated. In the above equation, when measuring the acoustic velocity, various instruments known in the art may be used, such as a Sonic Tester SST-110 (Nomura Shoji Co., Ltd.) and the like.

For imparting a preferred mean center line roughness to the surface of the raw paper, the raw paper is preferred to use a pulp fiber that has a fiber length distribution where a total of 24 mesh screen remnant and 42 mesh screen remnant is 20% by mass to 45% by mass, with the 24 mesh screen remnant of 5% by mass or less, as is disclosed in JP-A No. 58-68037. Moreover, the mean center line roughness can be adjusted through a surface treatment, with heat and pressure applied by means of a machine calender, a super calender and the like.

The thickness of the raw paper is not particularly limited, and can be suitably selected according to the object, preferably 30 μm to 500 μm, more preferably 50 μm to 300 μm, and still more preferably 100 μm to 250 μm. The basis weight of the raw paper is not particularly limited, and can be suitably selected according to the object, for example, it is preferably from 50 g/m² to 250 g/m², and more preferably from 100 g/m² to 200 g/m².

-Polyolefine Resin Layer-

The polyolefine resin layer of the support has a surface having the ten point height of roughness profile Rz, preferably in a range from 5 μm to 25 μm, more preferably in a range from 5 μm to 20 μm.

The ten point height of roughness profile Rz less than 5 μm may lose the silk tone effect and may increase visibility of the fingerprint, while the ten point height of roughness profile Rz more than 25 μm may roughen the image thus degrading the image and deteriorating the traveling property.

The average depression-and-protrusion space Sm on the surface of the polyolefine resin layer is preferably in a range from 100 μm to 1000 μm, more preferably in a range from 150 μm to 800 μm.

The average depression-and-protrusion space Sm less than 100 μm may lose the silk tone effect and may increase visibility of the fingerprint, while the average depression-and-protrusion space Sm more than 1000 μm may roughen the image.

Herein, the ten point height of roughness profile Rz and the average depression-and-protrusion space Sm on the surface of the polyolefine layer are pursuant to those specified in JIS B0601-1994 and can be measured with a surface profile measurement machine, where JIS stands for Japanese Industrial Standard.

As long as forming the ten point height of roughness profile Rz in a range from 5 μm to 25 μm and the average depression-and-protrusion space Sm in a range from 100 μm to 1000 μm, the method for roughening the surface of the polyolefine resin layer is not specifically limited, examples thereof including a sand blast method, a liquid honing method, a heat rolling method, a plasma ion machining method, an etching method with chemical, a molding method (pressing roughened member through carving treatment), and the like. Herein, each of the above methods is to be carried out on the surface of the polyolefine resin layer, substantially simultaneously with or immediately after a flow-rolling of the polyolefin resin that is melted on at least the face (of the raw paper) to be formed with the toner image-receiving layer.

The polyolefine is, in general, so often formed using a low-density polyethylene. For improving heat resistance of the support, however, such compositions are preferred as polypropylene, blend of polypropylene and polyethylene, high-density polyethylene, blend of high-density polyethylene and low-density polyethylene, and the like. In view of cost, laminatability and the like, the blend of high-density polyethylene and low-density polyethylene is especially preferable.

The high-density polyethylene and the low-density polyethylene is preferred to have blending ratio (mass ratio) in a range from 1/9 to 9/1, more preferably 2/8 to 8/2, and especially preferably 3/7 to 7/3.

For forming the thermoplastic resin layer on both faces of the support, the backface of the support is preferred to be formed using, for example, the high-density polyethylene, or the blend of the high-density polyethylene and the low-density polyethylene.

The polyethylene is not specifically limited, and can be suitably selected according to the object. In each of the high-density polyethylene and the low-density polyethylene, however, a melt-in index is preferred to be in a range from 1.0 g/10 min to 40 g/10 min.

The sheet and the film may be subjected to a treatment for imparting thereto a white reflectivity. Examples of the above treatment include a method of blending, in the sheet and the film, a pigment such as titanium oxide.

The thickness of the polyolefine resin layer is not specifically limited, preferably in a range from 15 μm to 50 μm, more preferably from 15 μm to 40 μm. The thickness less than 15 μm may make the molding difficult, while the thickness more than 50 μm may strengthen rigidity of the support.

The thickness of the support is not specifically limited, and can be suitably selected according to the object, preferably in a range from 25 μm to 300 μm, more preferably in a range from 50 μm to 260 μm, and especially preferably in a range from 75 μm to 220 μm.

The image recording material is not specifically limited, and can be suitably selected according to the object, examples thereof including an electrophotographic image-receiving sheet, a melted heat transferring-recording sheet, a sublimational heat transferring-recording sheet, a heat sensitive recording sheet, and an ink jet recording sheet, especially preferably is the electrophotographic image-receiving sheet.

Hereinafter described is specific explanation about the electrophotographic image-receiving sheet.

<Electrophotographic Image-Receiving Sheet>

The electrophotographic image-receiving sheet has i) the support ii) and at least one layer of toner image-receiving layer which is formed at least one face of the support. Moreover, the electrophotographic image-receiving sheet may have other layers suitably selected when necessary, examples thereof including: a surface protective layer, an intermediate layer, a back layer, an undercoat layer, a cushion layer, a charge control (inhibiting) layer, a reflecting layer, a tint adjusting layer, a preservability improving layer, an anti-adhering layer, an anti-curl layer, a smoothing layer, and the like. These layers may have a single-layer structure or may be formed of two or more layers (laminated structure).

As described above, the support is preferred to have the raw paper and the polyolefine resin layer which is formed at least on the face (of the raw paper) to be formed with the image recording layer. The polyolefine resin layer has the surface having the ten point height of roughness profile Rz in a range from 5 μm to 25 μm and the average depression-and-protrusion space Sm in a range from 100 μm to 1000 μm.

<Toner Image-Receiving Layer>

The toner image-receiving layer receives a color toner and a black toner, and forms the image. At a transferring operation, the toner image-receiving layer receives the toner for forming the image by (static) electricity, pressure and the like, from a developing drum or an intermediate transfer body. At a fixing operation, the toner image-receiving layer fixes the toner by heat, pressure and the like.

In view of making the electrophotographic image-receiving sheet of the present invention to have a feeling similar to a photograph, the toner image-receiving layer is preferred to have low light transmittance of 78% or less, more preferably 73% or less, especially preferably 72% or less.

The above light transmittance can be measured in the following manner: i) on a polyethylene terephthalate film (10 μm thick), form a coat film having the same thickness (10 μm), and ii) measure transmittance of the coat film with a direct-reading haze meter (HGM-2DP made by Suga Test Instruments Co., Ltd.).

The toner image-receiving layer contains at least a thermoplastic resin and, when necessary, various additives to be added for improving thermodynamic properties of the toner image-receiving layer. Examples of the additives include releasing agent, plasticizer, colorant, filler, cross-linking agent, charge control agent, emulsifier, dispersant, and the like.

-Thermoplastic Resin-

The thermoplastic resin can be any suitable thermoplastic resin according to the object. Examples thereof are (1) polyolefinic resins, (2) polystyrenic resins, (3) acrylic resins, (4) polyvinyl acetates and derivatives thereof, (5) polyamide resins, (6) polyester resins, (7) polycarbonate resins, (8) polyether resins (or acetal resins), and (9) other resins. These resins can be used alone or in combination of two or more. Among them, the styrenic resins, the acrylic resins and the polyester resins are preferred because they have a large aggregation energy and enable the toner to be satisfactorily embedded.

Examples of the polyolefinic resins (1) are polyolefin resins such as polyethylenes and polypropylenes; and copolymer resins of an olefin such as ethylene or propylene with other vinyl monomers. Examples of such copolymer resins (olefin and other vinyl monomers) are ethylene-vinyl acetate copolymers and ionomer resins including acrylic acid and methacrylic acid. Examples of the derivatives of polyolefin resins are chlorinated polyethylenes and chlorosulfonated polyethylenes.

Examples of the polystyrenic resins (2) are polystyrene resins, styrene-isobutylene copolymers, acrylonitrile-styrene copolymers (AS resins), acrylonitrile-butadiene-styrene copolymers (ABS resins), and polystyrene-maleic anhydride resins.

Examples of the acrylic resins (3) are polyacrylic acids and esters thereof, polymethacrylic acids and esters thereof, polyacrylonitriles, and polyacrylamides.

The esters of polyacrylic acids include, for example, homopolymers and multi-component copolymers of acrylic esters. Examples of the acrylic esters are methyl acrylate, ethyl acrylate, n-butyl acrylate, isobutyl acrylate, dodecyl acrylate, n-octyl acrylate, 2-ethylhexyl acrylate, 2-chloroethyl acrylate, phenyl acrylate, and methyl α-chloroacrylate.

The esters of polymethacrylic acids include, for example, homopolymers and multi-component copolymers of methacrylic esters. Examples of the methacrylic esters are methyl methacrylate, ethyl methacrylate and butyl methacrylate.

Examples of the polyvinyl acetates and derivatives thereof (4) are polyvinyl acetates, polyvinyl alcohols prepared by saponifying polyvinyl acetates, and polyvinylacetal resins prepared by reacting polyvinyl alcohol with an aldehyde (such as formaldehyde, acetaldehyde and butyraldehyde).

The polyamide resins (5) are polycondensates of diamine and dibasic acid, examples thereof including 6-nylon, 6,6-nylon, and the like.

The polyester resins (6) are prepared by polycondensation of acid component and alcohol component. The acid component can be any suitable one, and examples thereof are maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, trimellitic acid, pyromellitic acid, anhydrides and lower alkyl esters of these acids.

The alcohol component can be any suitable one according to the object. Among them, dihydric alcohols such as aliphatic diols and alkylene oxide adducts of bisphenol A are preferred. Examples of the aliphatic diols are ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetremethylene glycol. Examples of the alkylene oxide adducts of bisphenol A are polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, and polyoxypropylene (6)-2,2-bis(4-hydroxyphenyl)propane.

Examples of the polycarbonate resins (7) are polycarbonate esters derived from bisphenol A and phosgene.

Examples of the polyether resins or acetal resins (8) are polyether resins such as polyethylene oxides and polypropylene oxides; and acetal resins such as polyoxymethylenes prepared as a result of ring-opening polymerization.

The other resins (9) include, for example, polyurethane resins prepared as a result of polyaddition.

Preferably, the thermoplastic resin satisfies the requirements for the physical properties (to be described afterward) of the toner image-receiving layer comprising the thermoplastic resin in question, and more preferably can satisfy, by itself, the above requirements. It is also preferred that two or more resins exhibiting different physical properties (to be described afterward) as the toner image-receiving layer are used in combination.

The thermoplastic resin used in the toner image-receiving layer preferably has a molecular weight larger than that of a thermoplastic resin used in the toner. However, this relationship in molecular weight between two thermoplastic resins may not necessarily be applied to some cases in terms of thermodynamic property. For example, when the thermoplastic resin used in the toner image-receiving layer has a softening point higher than that of the thermoplastic resin used in the toner, the former thermoplastic resin may preferably have a molecular weight equivalent to or lower than that of the latter thermoplastic resin.

A mixture of resins having the same composition and different average molecular weights is also preferably used as the thermoplastic resin for the toner image-receiving layer. The relationship in molecular weight between the thermoplastic resin used in the toner image-receiving layer and that used in the toner is preferably the one disclosed in JP-A No. 08-334915.

The thermoplastic resin for the toner image-receiving layer preferably has a particle size distribution larger than that of the thermoplastic resin used in the toner.

The thermoplastic resin for the toner image-receiving layer preferably satisfies the requirements in physical properties as disclosed in, for example, JP-A No. 05-127413, JP-A No. 08-194394, JP-A No. 08-334915, JP-A No. 08-334916, JP-A No. 09-171265, and JP-A No. 10-221877.

As the thermoplastic resins for the toner image-receiving layer, aqueous resins such as water-dispersible polymers and water-soluble polymers are preferred for the following reasons.
(i) These aqueous resins do not invite exhaustion of an organic solvent in a coating-and-drying process and are thereby environmentally friendly and have good workability.
(ii) Many of waxes and other releasing agents cannot be significantly dissolved in solvents at room temperature and are often dispersed in a medium (water or an organic solvent) before use.
(iii) Such aqueous dispersions are more stable, and suitable in production processes. When an aqueous composition containing the thermoplastic resin and a wax is applied and dried, the wax readily bleeds out on the surface of a coated layer, thus yielding the effects of the releasing agent (anti-offset properties and adhesion resistance) more satisfactorily.

As long as being any one of water-dispersible polymer and water-soluble polymer, the aqueous resin can have any composition, bonding structure, molecular structure, molecular weight, molecular distribution, and mode, according to the object. Examples of the aqueous group of the above polymers are sulfonic group, hydroxyl group, carboxyl group, amino group, amido group, ether group, and the like.

The water-dispersible polymer can be selected from water-dispersed resins and emulsions of the thermoplastic resins (1) to (9) described above. Moreover, the water-dispersible polymer can be selected from copolymers, mixtures and cationic modified products of the thermoplastic resins (1) to (9) described-above. The above polymers can be used alone or in combination of two or more.

The water-dispersible polymer can be suitably synthesized or is available from commercial products. For example, water-dispersible polyester-based polymers are commercially available as the Vylonal Series from Toyobo Co., Ltd, the Pesresin A Series from Takamatsu Oil & Fat Co., Ltd., the Tuftone UE Series from Kao Corporation, the WR Series from Nippon Synthetic Chemical Industry Co., Ltd., and the Elitel Series from Unitika Ltd. Water-dispersible acrylic polymers are commercially available as the Hiros XE, KE and PE series from Seiko Chemical Industries Co., Ltd., and the Jurymer ET series from Nihon Junyaku Co., Ltd.

The water-dispersible emulsion can be any suitable emulsion mean, and can be suitably selected according to the object. Examples of such emulsions are water-dispersible polyurethane emulsions, water-dispersible polyester emulsions, chloroprene emulsions, styrene-butadiene emulsions, nitrile-butadiene emulsions, butadiene emulsions, vinyl chloride emulsions, vinylpyridine-styrene-butadiene emulsions, polybutene emulsions, polyethylene emulsions, vinyl acetate emulsions, ethylene-vinyl acetate emulsions, vinylidene chloride emulsions, and methyl methacrylate-butadiene emulsions. Among them, the water-dispersible polyester emulsions are preferred.

The water-dispersible polyester emulsions are preferably self-dispersible aqueous polyester emulsions, of which self-dispersible aqueous carboxyl group-containing polyester emulsions are especially preferred. The “self-dispersible aqueous polyester emulsion” herein means an aqueous emulsion containing a polyester resin that is self-dispersible in an aqueous solvent without the use of an emulsifier and the like. The “self-dispersible aqueous carboxyl group-containing polyester emulsion” means an aqueous emulsion containing a polyester resin that contains carboxyl groups as hydrophilic groups and is self-dispersible in an aqueous solvent.

The self-dispersible aqueous polyester emulsion described above preferably satisfies the following requirements (1) to (4). This type of polyester emulsion is self-dispersible using no surfactant, is low in moisture absorbency even in an atmosphere at high humidity, exhibits less decrease in its softening point due to moisture and can avoid offset in image-fixing and failures due to adhesion between sheets during storage. The above polyester emulsion is water-based and is therefore environmentally friendly and excellent in workability. In addition, the polyester resin used therein readily takes a molecular structure with high cohesive energy. Accordingly, the resin has sufficient hardness (rigidity) during its storage but is melted with low elasticity and low viscosity during an image-fixing process for electrophotography, and the toner is sufficiently embedded in the toner image-receiving layer to thereby form images having sufficiently high quality.
(1) The number-average molecular weight Mn is preferably from 5000 to 10000, and more preferably from 5000 to 7000.
(2) The molecular weight distribution (Mw/Mn) is preferably 4 or less, and more preferably 3 or less, where Mw is the weight-average molecular weight.
(3) The glass transition temperature Tg is preferably from 40° C. to 100° C., and more preferably from 50° C. to 80° C.
(4) The volume average particle diameter is preferably from 20 nm to 200 nm, and more preferably from 40 nm to 150 nm.

The content of the water-dispersible emulsion in the toner image-receiving layer is preferably from 10% by mass to 90% by mass, and more preferably from 10% by mass to 70% by mass.

The water-soluble polymer can be suitably selected according to the object, and can be suitably synthesized or is commercially available as products. Examples of such water-soluble polymers are polyvinyl alcohols, carboxy-modified polyvinyl alcohols, carboxymethylcellulose, hydroxyethylcellulose, cellulose sulfate, polyethylene oxides, gelatin, cationized starch, casein, polysodium acrylates, sodium styrene-maleic anhydride copolymers, and sodium polystyrene sulfonate, of which the polyethylene oxides are preferred.

The water-soluble polymers are commercially available as, for example, various Pluscoats from Goo Chemical Co., Ltd. and the Finetex ES series from Dainippon Ink & Chemicals Inc. Examples of water-soluble acrylics are the Jurymer AT series from Nihon Junyaku Co., Ltd., Finetex 6161 and K-96 from Dainippon Ink & Chemicals Inc., and Hiros NL-1189 and BH-997L from Seiko Chemical Industries Co., Ltd.

Typical disclosure of the water-soluble polymers can be found in, for example, Research Disclosure No.17,643, pp. 26; Research Disclosure No.18,716, pp. 651; Research Disclosure No. 307,105, pp. 873-874; and JP-A No. 64-13546 (in Japanese).

The content of the water-soluble polymer in the toner image-receiving layer can be any suitable one set according to the object and is preferably from 0.5 g/m² to 2 g/m².

The thermoplastic resin can be used in combination with other polymer materials. In this case, the thermoplastic resin is to be generally contained in a greater amount than the other polymer materials.

The content of the thermoplastic resin in the toner image-receiving layer is preferably 10% by mass or more, more preferably 30% by mass or more, further preferably 50% by mass or more, and especially preferably form 50% by mass to 90% by mass.

-Releasing Agent-

The releasing agent is blended in the toner image-receiving layer so as to prevent offset of the toner image-receiving layer. The releasing agents of the present invention are not specifically limited and can be appropriately selected, as long as they are melted or fused by heating at an image-fixing temperature, are deposited on the surface of the toner image-receiving layer and form a layer of the releasing agent on the surface by cooling and solidifying.

The releasing agent can be at least one of silicone compounds, fluorine compounds, waxes, and matting agents.

As the releasing agents, the compounds mentioned for example in “Properties and Applications of Waxes,” Revised Edition, published by Saiwai Shobo, or The Silicon Handbook published by THE NIKKAN KOGYO SHIMBUN may be used. Further, the silicon compounds, fluorine compounds or waxes used for the toners mentioned in JP-B Nos. 59-38581, 04-32380, Japanese Patents Nos. 2838498, 2949558, JP-A Nos. 50-117433, 52-52640, 57-148755, 61-62056, 61-62057, 61-118760, 0242451, 0341465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 1144969, 11-65156, 11-73049 and 11-194542 can also be used. Moreover, two or more sets of these compounds can be used.

Examples of the silicone compounds are silicone oils, silicone rubber, silicone fine particles, silicone-modified resins and reactive silicone compounds.

The above silicone oils include, for example, unmodified silicon oil, amino-modified silicone oil, carboxy-modified silicone oil, carbinol-modified silicone oil, vinyl-modified silicone oil, epoxy-modified silicone oil, polyether-modified silicone oil, silanol-modified silicone oil, methacrylic-modified silicone oil, mercapto-modified silicone oil, alcohol-modified silicone oil, alkyl-modified silicone oil, and fluorine-modified silicone oil.

Examples of the silicone-modified resins are silicone-modified resins derived from olefinic resins, polyester resins, vinyl resins, polyamide resins, cellulose resins, phenoxy resins, vinyl chloride-vinyl acetate resins, urethane resins, acrylic resins, styrene-acrylic resins, or derived from copolymers thereof.

The fluorine compounds can be any suitable one according to the object, and examples thereof are fluorocarbon oils, fluorocarbon rubber, fluorine-modified resins, fluorosulfonic acid compounds, fluorosulfonic acid, fluoric acid compounds or salts thereof, and inorganic fluorides.

The waxes are largely classified into natural waxes and synthetic waxes.

Preferred examples of the natural waxes are vegetable waxes, animal waxes, mineral waxes, and petroleum waxes, of which the vegetable waxes are especially preferred. As the natural waxes, water-dispersible waxes are preferred for their good compatibility in the case where an aqueous resin is used as the polymer for the toner image-receiving layer.

The vegetable waxes are not specifically limited and can be selected from known vegetable waxes such as properly synthesized products or commercially available products. Examples of the vegetable waxes are carnauba waxes, castor oil, rape oil, soybean oil, Japan tallow, cotton wax, rice wax, sugarcane wax, candelilla wax, Japan wax and jojoba oil.

The camauba wax is commercially available under the trade names of, for example, EMUSTAR-0413 from Nippon Seiro Co., Ltd., and SELOSOL from Chukyo Yushi Co., Ltd. The castor oil is commercially available as, for example, a purified castor oil from Itoh Oil Chemicals Co., Ltd.

Among them, for providing an electrophotographic image-receiving sheet capable of forming high-quality image, the carnauba waxes having a melting point of 70° C. to 95° C. are especially preferred, since the resulting image-receiving material has excellent anti-offset properties and adhesion resistance, can pass through a machine smoothly, has good glossiness, invites less cracking and can form high-quality images.

The animal waxes can be any suitable ones, and examples thereof are beeswaxes, lanolin, spermaceti waxes, whale oils, and wool waxes.

The mineral waxes can be any suitable ones such as commercially available products and properly synthesized products. Examples thereof are montan wax, montan ester wax, ozokerite, and ceresin.

Among them, the montan waxes having a melting point of 70° C. to 95° C. are preferred, since the resulting image-receiving material has excellent anti-offset properties and adhesion resistance, can pass through a machine smoothly, has good glossiness, invites less cracking and can form high-quality images.

The petroleum waxes can be any suitable ones such as commercially available products or properly synthesized products, and examples thereof are paraffin wax, microcrystalline wax and petrolatum.

The content of the natural wax in the toner image-receiving layer is preferably from 0.1 g/m² to 4 g/m², and more preferably from 0.2 g/m² to 2 g/m².

When the content is less than 0.1 g/m², sufficient anti-offset properties and adhesion resistance may not be obtained. When it exceeds 4 g/m², the resulting images may decrease quality due to excessive wax.

To obtain satisfactory anti-offset properties and to allow the sheet to pass through a machine smoothly, the melting point of the naturally occurring wax is preferably from 70° C. to 95° C., and more preferably from 75° C. to 90° C.

The synthetic waxes are classified into synthetic hydrocarbons, modified waxes, hydrogenated waxes, and other fats and oil-derived synthetic waxes. These waxes are preferably water-dispersible waxes for their good compatibility (miscibility) with an aqueous thermoplastic resin in the toner image-receiving layer.

Examples of the synthetic hydrocarbons are Fischer-Tropsch wax, polyethylene wax, and the like.

Examples of the fats and oil-derived synthetic waxes are acid amide compounds (such as stearamide), and acid imide compounds (such as anhydrous phthalimide).

The modified waxes include, but are not limited to, amine-modified wax, acrylic acid-modified wax, fluorine-modified wax, olefin-modified wax, urethane-type wax, and alcohol-type wax.

The hydrogenated waxes include, but are not limited to, hard castor oil, castor oil derivatives, stearic acid, lauric acid, myristic acid, palmitic acid, behenic acid, sebacic acid, undecylenic acid, heptyl acids, maleic acid, high grade maleic oils.

To obtain satisfactory anti-offset properties and to allow the sheet to pass through a machine smoothly, the melting point of the releasing agent is preferably from 70° C. to 95° C., and more preferably from 75° C. to 90° C.

The releasing agents to be added to the toner image-receiving layer can also be derivatives, oxides, purified products, and mixtures of the aforementioned substances. These releasing agents may each have reactive substituents.

The content of the releasing agent in the toner image-receiving layer is preferably from 1% by mass to 20% by mass, more preferably from 1% by mass to 8.0% by mass, and further preferably from 1% by mass to 5.0% by mass.

-Plasticizer-

The plasticizers can be any of known plasticizers. The plasticizers work to control the fluidizing and softening of the toner image-receiving layer by the action of heat and pressure applied in the fixing of the toner.

Typical disclosures of the plasticizers can be found in, for example, Kagaku Binran (Chemical Handbook), ed. by The Chemical Society of Japan, Maruzen Co., Ltd. Tokyo; Plasticizer, Theory and Application, edited and written by Koichi Murai and published by Saiwai Shobo; Volumes 1 and 2 of Studies on Plasticizer, edited by Polymer Chemistry Association; and Handbook on Compounding Ingredients for Rubbers and Plastics, edited by Rubber Digest Co.

Some plasticizers are referred to as high-boiling point organic solvents and thermal solvents in some publications. Examples of the above plasticizers are compounds including: esters (such as phthalic, phosphoric, fatty acids, abietic, adipic, sebacic, azelaic, benzoic, butyric, epoxidized fatty acids, glycolic, propionic, trimellitic, citric, sulfonic, carboxylic, succinic, maleic, fumaric, phthalic, and stearic acid); amides (such as aliphatic and sulfonic); ethers; alcohols; lactones; polyethylene oxides described in JP-A No. 59-83154, No. 59-178451, No. 59-178453, No. 59-178454, No. 59-178455, No. 59-178457, No. 62-174754, No. 62-245253, No. 61-209444, No. 61-200538, No. 62-8145, No. 62-9348, No. 62-30247, No. 62-136646, and No. 2-235694.

One or more of these plasticizers can be blended in the resin component.

Plasticizers having relatively low molecular weight can also be used herein. The molecular weight of the above plasticizer is preferably lower than that of a binder resin to be plasticized and is preferably 15000 or less, and more preferably 5000 or less. In the case of a polymer plasticizer, the polymer of the same kind as the binder resin to be plasticized is preferred. For example, low-molecular-weight polyesters are preferably used for plasticizing a polyester resin. In addition, oligomers can be used as the plasticizers.

In addition to the aforementioned compounds, the plasticizers are also commercially available under the trade names of, for example, Adekacizer PN-170 and PN-1430 from Asahi Denka Kogyo Co., Ltd.;

PARAPLEX G-25, G-30 and G-40 from C. P. Hall Co.; Ester Gum 8L-JA, Ester R-95, Pentalin 4851, FK 115,4820 and 830, Luisol 28-JA, Picolastic A75, Picotex LC and Crystalex 3085 from Rika Hercules Co.

The plasticizer can be arbitrarily used so as to mitigate stress and strain which may be caused when the toner particles are embedded in the toner image-receiving layer. The above strain includes, for example, physical strain such as elastic force and viscosity, and strain due to material balance in, for example, molecules, principal chains and pendant moieties of the binder.

The plasticizer may be finely (microscopically) dispersed, may undergo micro-phase separation into islands-in-sea structure, and may be sufficiently dissolved or miscible with other components such as a binder.

The content of the plasticizer in the toner image-receiving layer is preferably from 0.001% by mass to 90% by mass, more preferably from 0.1% by mass to 60% by mass, and further preferably from 1% by mass to 40% by mass.

The plasticizers can be used to control the slipping property (leading to the improvement in the transport performance due to friction reduction), improve the offset property during fixing (detachment of toner or layers onto the fixing portion), control the curling balance, and control the charging property (latent toner image formation).

-Colorant-

The colorant can be any suitable one according to the object, and examples thereof are fluorescent brightening agents, white pigments, colored pigments and dyes.

The above fluorescent brightening agent has absorption in the near-ultraviolet region, and is a compound which emits fluorescence at 400 nm to 500 nm. The various fluorescent brightening agents known in the art may be used without any particular limitation. As this fluorescent brightening agent, the compounds described in “The Chemistry of Synthetic Dyes” Volume V, Chapter 8 edited by K.

VeenRataraman can conveniently be mentioned. The fluorescent brightening agent can be any commercially available product and properly synthesized product, and examples thereof are stilbene compounds, coumarin compounds, biphenyl compounds, benzo-oxazoline compounds, naphthalimide compounds, pyrazoline compounds and carbostyril compounds. Examples of those commercially available are white furfar-PSN, PHR, HCS, PCS, B from Sumitomo Chemicals, and UVITEX-OB from Ciba-Geigy.

The white pigment can be any suitable one selected according to the object, and examples thereof are inorganic pigments such as titanium dioxide and calcium carbonate.

Examples of the colored pigments include, but are not limited to, pigments, azo pigments, polycyclic pigments, condensed polycyclic pigments, lake pigments and carbon black as described in, for example, JP-A No. 6344653.

Examples of the azo pigments are azo lakes such as carmine 6B and red 2B; insoluble azo pigments such as monoazo yellow, disazo yellow, pyrazolone orange, and Vulcan orange; and condensed azo compounds such as chromophthal yellow and chromophthal red.

Examples of the polycyclic pigments are phthalocyanine pigments such as copper phthalocyanine blue and copper phthalocyanine green.

Examples of the condensed polycyclic pigments are dioxazine pigments such as dioxazine violet; isoindolinone pigments such as isoindolinone yellow; threne pigments; perylene pigments; perinone pigments; and thioindigo pigments.

Examples of the lake pigments are malachite green, rhodamine B, rhodamine G, and Victoria blue B.

Examples of the inorganic pigments are oxides such as titanium dioxide and iron oxide red; sulfates such as precipitated barium sulfate; carbonates such as precipitated calcium carbonate; silicates such as hydrous silicates and anhydrous silicates; and metal powders such as aluminum powder, bronze powder, zinc powder, chrome yellow and iron blue.

These can be used alone or in combination of two or more.

The dye can be any suitable one selected according to the object, and examples thereof are anthraquinone compounds and azo compounds. These can be used alone or in combination of two or more.

Examples of the water-insoluble dyes are vat dyes, disperse dyes and oil-soluble dyes. The vat dyes include, but are not limited to, C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35. The disperse dyes include, but are not limited to, C. I. disperse violet 1, C. I. disperse violet 4, C. I. disperse violet 10, C. I. disperse blue 3, C. I. disperse blue 7 and C. I. disperse blue 58. The oil-soluble dyes include, but are not limited to, C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55.

Colored couplers used in silver halide photography may also be used preferably.

The amount (g/m²) of colorant in the above toner image-receiving layer is preferably 0.1 g/m² to 8 g/m²₁ and more preferably 0.5 g/m² to 5 g/m².

When the amount of colorant is less than 0.1 g/m², the light transmittance in the toner image-receiving layer may be high, and when the amount of the above colorant exceeds 8 g/m², handling may become difficult due to cracks, adhesion resistance and the like.

Of the above colorants, the added pigment is preferably 40% by mass or less based on the mass of the thermoplastic resin constituting the toner image-receiving layer, more preferably 30% by mass or less, and especially preferably 20% by mass or less.

The filler may be an organic or an inorganic filler, and reinforcers for binder resins, bulking agents and reinforcements known in the art may be used. The filler may be selected by referring to “Handbook of Rubber and Plastics Additives” (ed. Rubber Digest Co.), “Plastics Blending Agents—Basics and Applications” (New Edition) (Taisei Co.) and “The Filler Handbook” (Taisei Co.).

As the filler, inorganic fillers or inorganic pigments can be used. Examples of the inorganic fillers or the inorganic pigments are silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among the above, the silica and the alumina are particularly preferred. These fillers may be used alone, or in combination of two or more. It is preferred that the filler has a small particle diameter. When the particle diameter is large, the surface of the toner image-receiving layer tends to become rough (grained).

The silica includes spherical silica and amorphous silica. The silica may be synthesized by a dry method, a wet method and an aerogel method. The surface of the hydrophobic silica particles may also be treated by trimethylsilyl groups or silicone. In this case, colloidal silica is preferred. The silica is preferably porous.

Alumina includes anhydrous alumina and hydrated alumina.

Examples of crystallized anhydrous aluminas which may be used are α, β, γ, δ, ξ, η, θ, κ, ρ or χ. The hydrated alumina is more preferable than the anhydrous alumina. The hydrated alumina may be a monohydrate or trihydrate. The monohydrates include pseudo-boehmite, boehmite and diaspore. The trihydrates include gibbsite and bayerite. Porous alumina is preferred.

The alumina hydrate can be synthesized by the sol-gel method where ammonia is added to an aluminum salt solution to precipitate alumina, or by hydrolysis of an alkali aluminate. The anhydrous alumina can be obtained by dehydrating alumina hydrate by the action of heat.

The amount of the added filler is preferably 5 parts by mass to 2000 parts by mass relative to 100 parts by mass of the dry weight of the binder in the toner image-receiving layer.

A crosslinking agent can be blended in order to adjust the storage stability and thermoplastic properties of the toner image-receiving layer. Examples of the crosslinking agent are compounds containing two or more reactive groups in the molecule such as epoxy group, isocyanate group, aldehyde group, active halogen group, active methylene group, acetylene group and other reactive groups known in the art.

Otherwise, the crosslinking agent may also be a compound having two or more groups which are able to form bonds such as hydrogen bonds, ionic bonds and coordination bonds.

The crosslinking agent may be a compound known in the art such as a resin coupling agent, curing agent, polymerizing agent, polymerization promoter, coagulant, film-forming agent, and film-forming assistant. Examples of the coupling agents are chlorosilanes, vinylsilanes, epoxisilanes, arninosilanes, alkoxy aluminum chelates, titanate coupling agents and other agents known in the art such as those mentioned in “Handbook of Rubber and Plastics Additives” (ed. Rubber Digest Co.).

The toner image-receiving layer preferably comprises a charge control agent for controlling the transfer and adhesion of the toner and for preventing the adhesion of the toner image-receiving layer due to electrification.

The charge control agent can be any suitable one selected according to the object from those conventionally known in the art, and examples thereof are cationic surfactants, anionic surfactants, amphoteric surfactants, non-ionic surfactants, polymer electrolytes, electroconductive metal oxides, and the like. Specific examples of the charge control agents are cationic charge inhibitors such as quaternary ammonium salts, polyamine derivatives, cation-modified polymethyl methacrylate, cation-modified polystyrene; anionic charge inhibitors such as alkyl phosphates and anionic polymers; and non-ionic charge inhibitors such as fatty acid esters and polyethylene oxide.

When the toner is negatively charged, the charge control agent blended in the toner image-receiving layer is preferably cationic or nonionic.

Examples of the electroconductive metal oxides are ZnO, TiO₂, SnO₂, Al₂O₃, In₂O₃, SiO₂, MgO, BaO and MoO₃. These electroconductive metal oxides may be used alone or in combination of two or more. Also, the electroconductive metal oxide may contain (dope) other elements, for example, ZnO may contain Al, In and the like, TiO₂ may contain Nb, Ta and the like, and SnO₂ may contain Sb, Nb, halogen elements and the like.

-Other Additives-

The materials used to obtain the toner image-receiving layer of the present invention may also contain various additives to improve stability of the output image or improve stability of the toner image-receiving layer itself. Examples of the additives are known antioxidants, age resistors, degradation inhibitors, anti-ozone degradation inhibitors, ultraviolet light absorbers, metal complexes, light stabilizers, and preservatives (corrosion and mold).

The antioxidants can be any suitable one selected according to the object and examples thereof are chroman compounds, coumarane compounds, phenol compounds (e.g., hindered phenols), hydroquinone derivatives, hindered amine derivatives and spiroindan compounds. The antioxidants are given in JP-A No. 61-159644.

The age resistors can be any suitable one selected according to the object and examples thereof are given in “Handbook of Rubber and Plastics Additives,” Second Edition (1993, Rubber Digest Co.), p76-121.

The ultraviolet light absorbers can be any suitable one selected according to the object and examples thereof are benzotriazo compounds (U.S. Pat. No. 3,533,794), 4-thiazolidone compounds (U.S. Pat. No. 3,352,681), benzophenone compounds JP-A No. 46-2784) and ultraviolet light absorbing polymers JP-A No. 62-260152).

The metal complexes can be any suitable one selected according 2 0 to the object and examples thereof are given in U.S. Pat. Nos. 4,241,155, 4,245,018, and 4,254,195; and JP-A Nos. 61-88256, 62-174741, 63-199248, 01-75568, and 01-74272.

Ultraviolet absorbers and light stabilizers described in “Handbook on Compounding Ingredients for Rubbers and Plastics, revised second edition, p. 122-137 (1993), Rubber Digest Co.” can also be used.

Additives for photography known in the art may also be added to the material for the toner image-receiving layer, as described above. Examples of the photographic additives can be found in the Journal of Research Disclosure (hereinafter referred to as RD) No.17643 (December 1978), No.18716 (November 1979) and No. 307105 (November 1989). The relevant sections are shown in the following table 1.

TABLE 1

| Type of additive | RD17643 | RD18716 | RD307105 |
|---|---|---|---|
| 1. Brightening agent | p. 24 | p. 648 right column | p. 868 |
| 2. Stabilizer | pp. 24-25 | p. 649 right column | pp. 868-870 |
| 3. Light absorber | pp. 25-26 | p. 649 right column | p. 873 |
| (Ultraviolet ray | | | |
| absorber) | | | |
| 4. Colorant image | p. 25 | p. 650 right column | p. 872 |
| stabilizer | | | |
| 5. Film hardener | p. 26 | p. 651 left column | pp. 874-875 |
| 6. Binder | p. 26 | p. 651 left column | pp. 873-874 |
| 7. Plasticizer, lubricant | p. 27 | p. 650 right column | p. 876 |
| 8. Auxiliary application | pp. 26-27 | p. 650 right column | pp. 875-876 |
| agent (Surfactant) | | | |
| 9. Antistatic agent | p. 27 | p. 650 right column | pp. 876-877 |
| 10. Matting agent | | | pp. 878-879 |

The toner image-receiving layer of the present invention is formed by applying, with a wire coater and the like, the coating solution (containing thermoplastic resin for the toner image-receiving layer) to the support, and by drying it. A minimum film forming temperature (MFT) of the thermoplastic resin of the present invention is preferably the room temperature or higher, from the viewpoint of pre-print storage, and preferably 100° C. or lower, from the viewpoint of fixing toner particles.

Total thickness of the toner image-receiving layer is not particularly limited, and can be suitably selected according to the object. For example, the thickness is preferably 2 μm or more, more preferably from 2 μm to 50 μm, still more preferably 5 μm to 15 μm. The thickness less than 2 μm may make it difficult to form a mold with a specific roughness profile.

[Physical Properties of Toner Image-Receiving Layer]

The 180-degree peel strength of the toner image-receiving layer relative to a fixing member an image-fixing temperature is preferably 0.1 N/25 mm or less, and more preferably 0.041 N/25 mm or less at. The 180-degree peel strength can be determined according to a method specified in JIS K 6887 using a surface material of the fixing member.

It is preferred that the toner image-receiving layer has a high degree of whiteness. The whiteness is measured by the method specified in JIS P 8123, and is preferably 85% or more. It is preferred that the spectral reflectance is 85% or more in the wavelength region of 440 nm to 640 nm, and that the difference between the maximum spectral reflectance and the minimum spectral reflectance in this wavelength range is within 5%. Further, it is preferred that the spectral reflectance is 85% or more in the wavelength region of 400 nm to 700 nm, and that the difference between the maximum spectral reflectance and the minimum spectral reflectance in this wavelength range is within 5%.

Specifically, regarding the whiteness, an L* value is preferably 80 or more, preferably 85 or more, and still more preferably 90 or more in a CIE 1976 (L*a*b*) color space. A whiteness tone is preferably as neutral as possible. Regarding the whiteness tone, the value of (a*)²+(b*)² is preferably 50 or less, more preferably 18 or less, and still more preferably 5 or less in the (L*a*b*) space.

It is preferred that the toner image-receiving layer has a high gloss after the image is formed. The 45° gloss luster is preferably 60 or more, more preferably 75 or more, and still more preferably 90 or more, over the whole range from white where there is no toner, to black where toner is densed at maximum.

However, the gloss luster is preferably 110 or less. When it is more than 110, the image has a metallic luster which is undesirable.

Gloss luster may be measured based on JIS Z 8741.

It is preferred that the toner image-receiving layer has high smoothness after fixing. The arithmetic average roughness (Ra) is preferably 3 μm or less, more preferably 1 μm or less, and still more preferably 0.5 μm or less, over the whole range from white where there is no toner, to black where toner is densed at maximum.

The above arithmetic average roughness may be measured, for example, based on JIS B 0601, JIS B 0651, and JIS B 0652.

It is preferred that the toner image-receiving layer has one of the following physical properties, is more preferred that the toner image-receiving layer has several of the following physical properties, and is most preferred that the toner image-receiving layer has all of the following physical properties.
(1) Tₘ (melting temperature of toner image-receiving layer) is preferably 30° C. or more, and more preferably equal to or less than Tₘ (melting temperature of toner)+20° C.
(2) The temperature at which the viscosity of the toner image-receiving layer is 1×10⁵ cp is preferably 40° C. or higher, and more preferably lower than the corresponding temperature for the toner.
(3) At a fixing temperature of the toner image-receiving layer, the storage elasticity modulus (G′) is preferably 1×10² Pa to 1×10⁵ Pa, the loss elasticity modulus (G″) is preferably from 1×10² Pa to 1×10⁵ Pa.
(4) The loss tangent (G″/G′), which is the ratio of the loss elasticity modulus (G″) to the storage elasticity modulus (G′) at a fixing temperature of the toner image-receiving layer, is preferably from 0.01 to 10.
(5) The storage elasticity modulus (G′) at a fixing temperature of the toner image-receiving layer is preferably from −50 to +2500, relative to the storage elasticity modulus (G′) at a fixing temperature of the toner.
(6) The inclination angle of the molten toner on the toner image-receiving layer is preferably 50° or less, and more preferably 40° or less.

The toner image-receiving layer preferably satisfies the physical properties described in Japanese Patent No. 2788358, and JP-A Nos. 07-248637, 08-305067 and 10-239889.

It is preferred that the surface electrical resistance of the toner image-receiving layer is 1×10⁶ Ω/cm² to 1×10¹⁵ Ω/cm² (under conditions of 25° C., 65% RH).

When the surface electrical resistance is less than 1×10⁶ Ω/cm², the toner amount transferred to the toner image-receiving layer is insufficient, and the density of the toner image obtained may be too low. On the other hand, when the surface electrical resistance is more than 1×10¹⁵ Ω/cm², more charge than necessary is produced during transfer, therefore, the toner is transferred insufficiently, the image density is low, and the static electricity develops during handling of the electrophotographic image-receiving sheet, thus causing dust to adhere. Moreover in this case, misfeed, overfeed, discharge marks, toner transfer dropout and the like may occur during the copying.

The surface electrical resistances hereinabove are measured based on JIS K 6911. The sample is to be left with air-conditioning for 8 hours or more at a temperature of 20° C. and the humidity of 65%. Measurements are made using an R8340 produced by Advantest Ltd., under the same environmental conditions after giving an electric current for 1 minute at an applied voltage of 100 V.

-Other Layers-

Other layers of the electrophotographic image-receiving sheet may include, for example, a surface protective layer, a back layer, a contact improving layer, an intermediate layer, an undercoat layer, a cushion layer, a charge control (inhibiting) layer, a reflecting layer, a tint adjusting layer, a preservability improving layer, an anti-adhering layer, an anti-curl layer, a smoothing layer and the like. These layers may have a single-layer structure or may be formed of two or more layers.

-Surface Protective Layer-

The surface protective layer is formed on the surface of the electrophotographic image-receiving sheet for the purpose of protecting the surface, improving preservability, improving handling property, giving writing property, improving machine passing property, giving antioffset property and the like. The surface protective layer may have a single-layer structure or may be formed of two or more layers. As a binder, various kinds of thermoplastic resins, thermosetting resins and the like may be used for the surface protective layer. Resins of the binder and the toner image-receiving layer are preferably of the same kind. In this case, however, the surface protective layer and the toner image-receiving layer do not need to be the same in terms of thermodynamic property, electrostatic property and the like. Those properties of the surface protective layer can be optimized.

The surface protective layer can be blended with the various additives described above that are usable for the toner image-receiving layer. Particularly, the surface protective layer can be blended with the releasing agent used of the present invention, and with other additives such as matting agent and the like. Various known matting agents are named.

The top surface layer of the electrophotographic image-receiving sheet (for example, the surface protective layer when it is formed) is preferred to have compatibility with the toner in terms of fixation property. Specifically, the top surface layer preferably has a contact angle with the melted toner, for example, in a range from 0° to 40°.

The back layer of the electrophotographic image-receiving sheet is preferably formed on an opposite side of the toner image-receiving layer with respect to the support, for the purpose of giving a backface output property, improving output image quality of the backface, improving curl balance, improving machine passing property and the like.

Color of the back layer is not particularly limited. In the case of both-side output type image-receiving sheet forming the image also on the backface, however, the color of the back layer is also preferred to be white. Like the surface, the back layer is preferred to have whiteness of 85% or more and spectral reflectance of 85% or more.

Moreover, for improving both-side output property, the back layer may have a structure same as that of the toner image-receiving layer's side. The back layer may use the various additives as explained above. Examples of the additives to be blended include matting agent, charge control agent and the like. The back layer may have a single-layer structure or may be formed of two or more layers.

When a mold-releasing oil is used for a fixing roller and the like for preventing offset during the fixing, the back layer may have oil absorbing property.

Ordinarily, the back layer has a preferable thickness in a range from 0.1 μm to 10 μm.

-Contact Improving Layer-

In the electrophotographic image-receiving sheet, the above contact improving layer is preferred to be formed for improving the contact of the support and the toner image-receiving layer. The contact improving layer may be blended with various additives described above, preferably the cross-linking agent. Moreover, the electrophotographic image-receiving sheet of the present invention is preferred to have a cushion layer and the like between the contact improving layer and the toner image-receiving layer, for improving receptivity of the toner.

-Intermediate Layer-

The intermediate layer may be formed, for example, between the support and the contact improving layer, between the contact improving layer and the cushion layer, between the cushion layer and the toner image-receiving layer, between the toner image-receiving layer and the preservability improving layer, and the like. In the case of the electrophotographic image-receiving sheet that is formed with the support, the toner image-receiving layer, and the intermediate layer, the intermediate layer can be formed, for example, between the support and the toner image-receiving layer.

Thickness of the electrophotographic image-receiving sheet of the present invention is not specifically limited, and can be suitably selected according to the object, examples thereof including 50 μm to 550 μm (preferable) and 100 μm to 350 μm (more preferable).

<Toner>

The electrophotographic image-receiving sheet of the present invention is used by allowing the toner image-receiving layer to receive the toner during printing and copying.

The toner includes at least a binder resin and a colorant, and may further include, when necessary, a releasing agent and other agents.

-Toner's Binder Resin-

The binder resin is not particularly limited, and can be selected, according to the object, from those ordinarily used for the toner. Examples of the binder resin include vinyl monopolymer of: styrenes such as styrene, parachlorostyrene, and the like; vinyl esters such as vinyl naphthalene, vinyl chloride, vinyl bromide, vinyl fluoride, vinyl acetate, vinyl propioniate, vinyl benzoate, vinyl butyrate, and the like; methylene aliphatic carboxylates such as methyl acrylate, ethyl acrylate, n-butyl acrylate, isobutyl acrylate, dodecyl acrylate, n-octyl acrylate, 2-chloroethyl acrylate, phenyl acrylate, a-methyl chloroacrylate, methyl methacrylate, ethyl methacrylate, butyl acrylate, and the like; vinyl nitriles such as acrylonitrile, methacrylonitrile, acrylamide, and the like; vinyl ethers such as vinyl methyl ether, vinyl ethyl ether, vinyl isobutyl ether, and the like; N-vinyl compounds such as N-vinyl pyrrole, N-vinylcarbazole, N-vinyl indole, N-vinyl pyrrolidone, and the like; and vinyl carboxylic acids such as methacrylic acid, acrylic acid, cinnamic acid, and the like. These vinyl monomers may be used either alone, or copolymers thereof may be used. Further, various polyesters may be used, and various waxes may be used in combination.

Among these resins, it is preferable to use a resin same as that used for the toner image-receiving layer of the present invention.

Toner's Colorant-

The colorant is not particularly limited, and can be selected according to the object from those used ordinarily for the toner. Examples of the colorants include various kinds of pigments such as carbon black, chrome yellow, Hansa yellow, Benzidine Yellow, threne yellow, quinoline yellow, permanent orange GTR, pyrazolone orange, Vulcan orange, watch young red, permanent red, brilliant carmine 3B, brilliant carmine 6B, dippon oil red, pyrazolone red, lithol red, rhodamine B lake, lake red C, Rose Bengale, aniline blue, ultramarine blue, chalco oil blue, methylene blue chloride, phthalocyanine blue, phthalocyanine green, malachite green oxalate and the like. Other examples include various kinds of dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenyl methane dyes, diphenyl methane dyes, thiazine dyes, thiazole dyes, xanthene dyes and the like.

The above colorants may be used alone or in combination of two or more.

A content of the colorant is not particularly limited, and can be suitably selected according to the object, preferably 2% by mass to 8% by mass. The content of the colorant less than 2% by mass may weaken tinting strength, while more than 8% by mass may lose transmittance.

-Toner's Releasing Agent-

The releasing agent may be in principle any of the waxes known in the art. Polar waxes containing nitrogen such as highly crystalline polyethylene wax having relatively low molecular weight, Fischertropsch wax, amide wax, urethane wax, and the like are particularly effective.

For polyethylene wax, it is effective when the molecular weight is 1000 or less, and is more preferable when the molecular weight is 300 to 1000.

Since the compounds containing the urethane bonds tend to stay in a solid state due to the strength of the cohesive force of the polar groups even though the molecular weight is low, and since the melting point may be set high for the molecular weight, such compounds are suitable in general. The preferred molecular weight is 300 to 1000. The raw materials may be selected from various combinations such as diisocyanic acid compound with mono-alcohol, monoisocyanic acid with mono-alcohol, dialcohol with mono-isocyanic acid, tri-alcohol with monoisocyanic acid, and triisocyanic acid compound with mono-alcohol. However, in order to prevent the molecular weight from becoming too large, it is preferable to combine a compound having multiple functional groups with another compound having a single functional group, and it is important that the amount of functional groups is equivalent.

Examples of the monoisocyanic acid compounds include dodecyl isocyanate (and derivatives thereof), phenyl isocyanate (and derivatives thereof), naphthyl isocyanate, hexyl isocyanate, benzil isocyanate, butyl isocyanate, allyl isocyanate, and the like.

Examples of the diisocyanic acid compounds include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate, isophorone diisocyanate, and the like.

Examples of the monoalcohols include methanol, ethanol, propanol, butanol, pentanol, hexanol, heptanol, and the like.

Examples of the dialcohols include various glycols such as ethylene glycol, diethylene glycol, triethylene glycol, trimethylene glycol, and the like.

Examples of the trialcohols include trimethylol propane, triethylol propane, trimethanol ethane, and the like.

Like an ordinary releasing agent, the above urethane compounds can be mixed with resin or colorant during mixing-kneading, to be used as mixed-kneaded-pulverized toner. When used for the toner of the emulsion polymerization cohesive melting method, the urethane compounds are to be dispersed in water in combination with the ion surfactant or high molecular electrolyte (such as high molecular acid or high molecular base), and then heated to the melting point or more, then subjected to a strong shearing caused by homogenizer or pressure discharge type dispersing apparatus for forming fine-particles, to thereby prepare releasing agent particle-containing dispersing liquid (particle: 1 μm or less) which can be used in combination with the resin particle-containing dispersing liquid, the colorant-containing dispersing liquid and the like.

Content of the releasing agent in the toner is not specifically limited, and can be suitably selected according to the object, examples thereof including 1% by mass to 20% by mass (preferable) and 1% by mass to 10% by mass (more preferable).

-Other Components of Toner-

The toner can be blended with other components such as inner additive, charge control agent, inorganic fine-particle, and the like. Examples of the inner additives include metals such as ferrite, magnetite, reduced iron, cobalt, nickel, manganese and the like; alloy; magnetic bodies such as compounds including the above metals; and the like.

Examples of charge control agents include those ordinarily used such as quaternary ammonium salt compounds, nigrosine compounds, dyes made of complexes (such as aluminum, iron, chrome, and the like), triphenyl methane pigments, and the like. It is preferable that the charge control agent is unlikely to be dissolved in water, from the view point of controlling ion strength which may cause an effect on stability during coagulation (cohesion) or melting, and from the viewpoint of reducing waste water pollutant.

Examples of the inorganic fine-particles include all ordinary outer additives of the toner surface such as silica, alumina, titania, calcium carbonate, magnesium carbonate, tricalcium phosphate and the like. The above particles are preferably used by being dispersed with ion surfactant, high molecular acid, and high molecular base.

Surfactants may also be used for emulsion polymerization, seed polymerization, pigment dispersion, resin particle dispersion, releasing agent dispersion, coagulation (cohesion) and stabilization thereof. For example, it is effective to use, in combination, anionic surfactants such as sulfuric acid ester salts, sulfonic acid salts, phosphoric acid esters, soaps, and the like; cationic surfactants such as amine salts, quaternary ammonium salts, and the like; and non-ionic surfactants such as polyethylene glycols, alkylphenol ethylene oxide adducts, polybasic alcohols, and the like. These may generally be dispersed by a rotary shear homogenizer. Other dispersing measures include a ball mill, a sand mill, a dyno mill and the like all of which contain the media.

When necessary, the toner may be added by an outer additive. Examples of the outer additives include inorganic particle and organic particle. Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃, 2SiO₂, CaCO₃, MgCO₃, BaSO₄, MgSO₄ and the like. Examples of the organic particles include fatty acids and derivatives thereof, powders of the above metal salts and the like, resin particles (such as fluorine resin, polyethylene resin, acrylic resin and the like), and the like.

Average particle diameter of the above particles is preferably from 0.01 μm to 5 μm, more preferably from 0.1 μm to 2 μm.

There is no particular limitation on the process of manufacturing the toner, but it is preferably manufactured by a process comprising the operations of (i) forming cohesive particles in a dispersion of resin particles to prepare a cohesive particle dispersion, (ii) adding a fine particle dispersion to the cohesive particle dispersion so that the fine particles adhere to the cohesive particles, thus forming adhesive particles, and (iii) heating the adhesive particles which is then melt to form toner particles.

-Physical Properties of Toner-

The toner preferably has a volume average particle diameter of 0.5 μm to 10 μm. Lower than the above range may cause a harmful effect on the toner's handling (supplying property, cleanability, fluidity and the like), and may decrease particle productivity. Larger than the above range, on the other hand, may cause harmful effect on image and resolution attributable to graininess and transferability.

It is preferable that the toner of the present invention satisfies the above range of volume average particle diameter and has a distribution index of volume average particle diameter (GSDv) of 1.3 or less.

The ratio (GSDv/GSDn) of the distribution index of volume average particle diameter (GSDv) to a distribution index of number average particle diameter (GSDn) is preferably 0.95 or more.

It is preferable that the toner of the present invention satisfies the above range of volume average particle diameter and has an average (1.00 to 1.50) of profile factors given by the following expression.
Profile factor=(π×L²)/(4×S)
(where L denotes the maximum length of toner particle, and S denotes projected area of toner particle)

The toner satisfying the above conditions can bring about an effect on image quality, particularly graininess and resolution. Moreover in this case, dropout or blur which may be caused by transfer is unlikely to occur, and handling may be unlikely to be adversely influenced even when the average particle diameter becomes small.

From the viewpoint of improving image quality and preventing offset during the fixing operation, it is preferable that the toner in itself has storage elasticity modulus G′ (measured at angle frequency of 10 rad/sec) of 1×10² Pa to 1×10⁵ Pa at 150° C.

<Ink Jet Recording Sheet>

The above ink jet recording sheet includes, for example, the one having a colorant receiving layer disposed on the support, where the colorant receiving layer can receive inks such as i) an aqueous ink (using, as a colorant, dye or pigment), ii) a liquid ink such as an oil ink, and iii) a solid ink that is solid at an ordinary temperature and melted-liquefied for printing.

<Heat Transfer Sheet>

The heat transfer sheet includes, for example, a support and at least a heat-melting ink receiving layer disposed on the support.

Heating with a heat sensitive head can transfer the ink from the heat-melting ink receiving layer to the heat transfer sheet (melting-transferring method).

<Sublimational Transfer Sheet>

The sublimational transfer sheet includes, for example, a support and at least a heat-diffusive pigment (sublimational pigment) receiving layer disposed on the support.

Heating with a heat sensitive head can transfer the heat-diffusive pigment from an ink layer to the sublimational transfer sheet (sublimational transferring method).

<Heat Sensitive Recording Sheet>

The heat sensitive recording sheet includes, for example, a support and at least a heat-coloring layer disposed on the support. Repeated operations of heating with a heat sensitive head and fixing by ultraviolet rays can form the image (thermo auto chrome method (TA method)).

(Depression-and-Protrusion Forming Method)

The depression-and-protrusion forming method of the present invention, according to its first aspect comprises: heating at least a part of an image face of an image recording material after an image recording; and transferring to the thus heated image face a depression-and-protrusion by pressing to the heated image face a molding member having a surface formed with the depression-and-protrusion, the depression-and-protrusion defining a slope inclined from the image face, wherein the depression-and-protrusion has a ten point height of roughness profile Rz in a range from 5 μm to 25 μm and has an average depression-and-protrusion space Sm defined in JIS B0601-1994 in a range from 100 μm to 1000 μm. The depression-and-protrusion forming method of the present invention according to its first aspect further comprises cooling and peeling, when necessary, another operation.

Of the present invention, at least a part (preferably, most part; more preferably, substantially entirety) of the image face of the image recording material after the image recording is heated, then the molding member having the surface formed with the depression-and-protrusion is pressed, to thereby transfer the depression-and-protrusion defining a slope inclined from the image face.

The ten point height of roughness profile Rz is preferably in a range from 5 μm to 25 μm, more preferably 5 μm to 20 μm.

The average depression-and-protrusion space Sm is preferably in a range from 100 μm to 1000 μm, more preferably 150 μm to 800 μm.

As long as forming on the image face after the image recording the depression-and-protrusion having the ten point height of roughness profile Rz in a range from 5 μm to 25 μm and the average depression-and-protrusion space Sm in a range from 100 μm to 1000 μm, a method of forming the depression-and-protrusion on a surface of the molding member is not specifically limited, and can be suitably selected according to the object, examples thereof including: i) directly forming the depression-and-protrusion on the molding member, including; a) a sand blast method (by a specific single dispersing particle), b) a heat rolling method, and c) a plasma ion machining method; ii) once forming the regularity on a surface of a metal and the like, and then transferring the depression-and-protrusion to the molding member.

The above heating temperature is preferred to be the fluidity starting temperature or more of the thermoplastic resin of the image face. In the case that the image recording material is the electrophotographic image-receiving sheet, however, the heating temperature is preferred to be any one of i) the fluidity starting temperature or more of the thermoplastic resin of the toner image-receiving layer, and ii) the fluidity starting temperature or more of the binder of the toner received in the toner image-receiving layer.

The heating temperature is ordinarily 80° C. to 120° C. For the thermoplastic resin layer including the polyethylene resin as its main component, the heating temperature is preferred to be 95° C. to 110° C.

The heating method is not specifically limited, and can be suitably selected according to the object, examples thereof including infrared lamp, electric heating plate, heater, hot stamp, a pair of heating rollers, and the like.

The above depression-and-protrusion forming method is preferable in that the image recording material with the depression-and-protrusion transferred in the depression-and-protrusion transferring is cooled and peeled, to thereby form an accurate profile of depression-and-protrusion.

The above cooling is preferred to be carried out at less than the fluidity starting temperature of the thermoplastic resin of the image face. In the case that the image recording material is the electrophotographic image-receiving sheet, however, the cooling temperature is preferred to be any one of i) less than the fluidity starting temperature of the thermoplastic resin of the toner image-receiving layer, and ii) less than the fluidity starting temperature of the binder of the toner received in the toner image-receiving layer.

The cooling temperature is not specifically limited, and can be suitably selected according to the object, a preferable example thereof being 80° C. or less.

The cooling method is not specifically limited, and can be suitably selected according to the object, examples thereof including a cooler and a heat sink which are capable of sending cooled air and adjusting cooling temperature and the like.

The peeling method is not specifically limited, and can be suitably selected according to the object, examples thereof including a method of peeling the image recording material from the belt by means of rigidity (strength) of the image recording material itself.

The molding member is preferred to be at least one selected from a belt, a stamper, and a roller. Among the above, the belt is especially preferred.

An endless flexible belt is preferred.

The belt is preferred to have a heat resistant belt support and a mold-releasing layer on the heat resistant belt support.

Materials for the belt support is not specifically limited, and can be suitably selected according to the object, examples thereof including polyimide (PI), polyethylene naphthalate (PEN), polyethylene terephthalate (PET), polyether ether ether ketone (PEEK), polyether sulfone (PES), poly ether imide (PEI), poly parabanic acid (PPA), and the like.

The mold-releasing layer is preferred to be at least one selected from silicone rubber, fluorine rubber, fluorocarbon siloxane rubber, silicone resin, and fluorine resin. Among the above, the following i) and ii) are preferred: i) fluorocarbon siloxane rubber layer disposed on the surface of the fixing belt, and ii) the silicone rubber layer disposed on the surface of the belt member, and the fluorocarbon siloxane rubber layer disposed on the surface of the silicone rubber layer.

Thickness of the mold-releasing layer to be formed on the surface of the belt support is not specifically limited, and can be selected according to the object, examples thereof including 1 μm to 200 μm, more preferably 5 μm to 150 μm.

It is preferred that the fluorocarbon siloxane rubber of the fluorocarbon siloxane rubber layer has, in the principal chain, at least one of a perfluoroalkyl ether group and a perfluoroalkyl group.

As the fluorocarbon siloxane rubber, a cured product of a fluorocarbon siloxane rubber composition containing the components (A)-(D) below are preferred.
Component (A): a fluorocarbon polymer having, as its principal component, a fluorocarbon siloxane represented by the following structural formula (1) below, and containing aliphatic unsaturated groups,
Component (B): at least one of organopolysiloxane and fluorocarbon siloxane, each of which having two or more ≡SiH groups per molecule in a content of one to four times by mole the amount of the aliphatic unsaturated group in the fluorocarbon siloxane rubber composition,
Component (C): a filler, and
Component (D): an effective amount of catalyst.

The fluorocarbon polymer of the component (A) comprises, as its principal component, a fluorocarbon siloxane containing a repeating unit represented by the following structural formula (1), and contains aliphatic unsaturated groups.

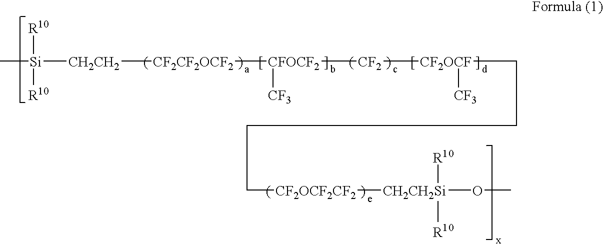

In the structural formula (1), R¹⁰ is an unsubstituted or substituted monovalent hydrocarbon group having 1 to 8 carbon atoms. The monovalent hydrocarbon group is preferably an alkyl group having 1 to 8 carbon atoms or an alkenyl group having 2 to 3 carbon atoms, of which a methyl group is especially preferred. The repetition numbers a and e are each an integer of 0 or 1, b and d are each an integer of 1 to 4, and c is an integer of 0 to 8. The repetition number x is preferably an integer of 1 or more, and is more preferably an integer of 10 to 30.

An example of the above component (A) is the substance represented by the following structural formula (2):

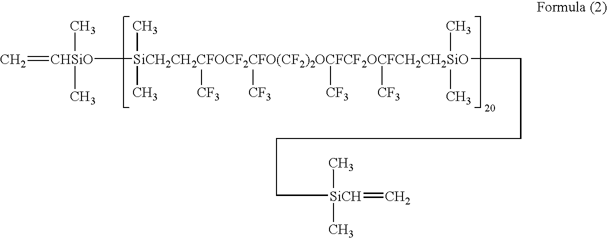

In the component (B), one example of the organopolysiloxane comprising ≡SiH groups is an organohydrogen polysiloxane having in the molecule at least two hydrogen atoms bonded to silicon atoms.

In the fluorocarbon siloxane rubber composition, when the fluorocarbon polymer of the component (A) comprises an aliphatic unsaturated group, the above organohydrogen polysiloxane may be preferably used as a curing agent. Specifically, in this case, a cured product is formed by an addition reaction between aliphatic unsaturated groups in the fluorocarbon siloxane, and hydrogen atoms bonded to silicon atoms in the organohydrogen polysiloxane.

Examples of the organohydrogen polysiloxanes are the various organohydrogen polysiloxanes used in addition-curing silicone rubber compositions.

The organohydrogen polysiloxane is preferably contained so that the number of ≡SiH groups therein is at least one, relative to one aliphatic unsaturated hydrocarbon group in the fluorocarbon siloxane of the component (A), and more preferably one to five ≡SiH groups are contained therein.

In the fluorocarbon containing the ≡SiH groups, a unit of the structural formula (1) or R¹⁰ in the structural formula (1) is preferred to be a dialkylhydrogen siloxane group, and the terminal group is preferred to be a ≡SiH group such as dialkylhydrogen siloxane group or silyl group. The terminal group can be represented by the following structural formula (3).

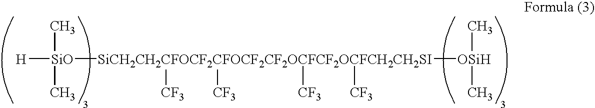

The filler which is the component (C) may be various fillers used in ordinary silicone rubber compositions. Examples are reinforcing fillers such as mist silica, precipitated silica, carbon powder, titanium dioxide, aluminum oxide, quartz powder, talc, sericite and bentonite; fiber fillers such as asbestos, glass fiber, and organic fibers; and the like.

Examples of the catalyst which is the component (D) are chloroplatinic acid which is known in the art as an addition reaction catalyst; alcohol-modified chloroplatinic acid; complexes of chloroplatinic acid and olefins; platinum black or palladium supported on a carrier such as alumina, silica and carbon; and Group VIII elements of the Periodic Table or their compounds such as complexes of rhodium and olefins, chlorotris(triphenylphosphine) rhodium (Wilkinson catalyst), and rhodium (III) acetyl acetonate. It is preferable to dissolve these complexes in solvents such as alcohol compound, ether compound and hydrocarbon compound.

The fluorocarbon siloxane rubber composition for use herein may further comprise various additives or blending agents according to the object. For example, dispersing agents such as diphenylsilane diol, low polymer chain end hydroxyl group-blocked dimethyl polysiloxane and hexamethyl disilazane; heat resistance improvers such as ferrous oxide, ferric oxide, cerium oxide and octyl acid iron; and colorants such as pigments may be added when necessary.

The belt member is obtained by coating the surface of the belt support with the above fluorocarbon siloxane rubber composition, and then heating-curing it. When necessary, for preparing a coating solution, the composition may be diluted with solvent such as m-xylene hexafluoride and benzotrifluoride, which solution can be then applied by an ordinary coating method such as spray coating, dip coating and knife coating. The heating-curing temperature and time can be conveniently selected, but the selection is generally made, according to the support film type and manufacturing method, within the ranges of 100° C. to 500° C. and 5 seconds to 5 hours.

The depression-and-protrusion forming method of the present invention, according to its second aspect, comprises: disposing an image recording layer on a support, the support's side to be formed with the image recording layer having a first depression-and-protrusion which has a ten point height of roughness profile Rz in a range from 5 μm to 25 μm and has an average depression-and-protrusion space Sm defined in JIS B0601-1994 in a range from 100 μm to 1000 μm; and recording an image on the image recording layer, to thereby form on an image face of the image recording layer a second depression-and-protrusion defining a slope inclined from the image face, wherein the second depression-and-protrusion of the image face has a ten point height of roughness profile Rz in a range from 5 μm to 25 μm and has an average depression-and-protrusion space Sm in a range from 100 μm to 1000 μm. When necessary, the depression-and-protrusion forming method of the present invention according to its second aspect further comprises another operation.

The ten point height of roughness profile Rz of the support and the image face is preferably in a range from 5 μm to 25 μm, more preferably 5 μm to 20 μm.

The average depression-and-protrusion space Sm of the support and the image face is preferably in a range from 100 μm to 1000 μm, more preferably 150 μm to 800 μm.

The method of recording the image recording layer to the support is not specifically limited, and can be selected according to the object, depending on the type of the image recording material, examples of the methods including spin coat method, spray coat method, scan coat method, dip coat method, kneader coat method, curtain coat method, blade coat method and the like.

Of the present invention, the depression-and-protrusion forming method subjecting the image face to a simple treatment can effectively form the depression-and-protrusion defining a slope inclined from the image face, the ten point height of roughness profile Rz in a range from 5 μm to 25 μm and the average depression-and-protrusion space Sm in a range from 100 μm to 1000 μm.

Hereinafter described are examples of the present invention. The present invention is, however, not limited to the examples. (Example 1 to example 4, and comparative example 1 to comparative example 3)

-Preparing Support-

A wood pulp made of LBKP (broad-leaf kraft pulp, bleaching pulp) was beaten to 300 ml of Canadian Standard Freeness (C. S. F.) using a double disk refiner, to thereby obtain a pulp material.

To this pulp material of 100 mass parts, the following additives were added: 1.0 mass part of cationic starch, 0.5 mass part of alkyl ketene dimer, 0.5 mass part of epoxidized fatty acid amide, 0.3 mass part of polyamine polyamide epichlorohydrine, 0.3 mass part of high fatty acid ester, and 0.02 mass part of colloidal silica. The thus obtained was subjected to a paper machining with a Fourdrinier (long-net) paper-making machine to thereby prepare a basic weight of 165 g/m², and then was subjected to a calendering to thereby obtain raw paper having thickness of 155 μm to 175 μm (density of 1.06 g/cm³ to 0.94 g/cm³).

The raw paper was traveled at 150 m/min such that a backface of the raw paper was subjected to a corona discharge. Then, (1) a backface polyethylene resin layer having 10 mass parts of low-density polyethylene (density of 0.924 g/cm³, MFR=3 g/10 min), 90 mass parts of high-density polyethylene (density of 0.966 g/cm³, MFR=11 g/10 min), and a thickness of 10 μm; and (2) an outermost polyethylene having 50 mass parts of low-density polyethylene (density of 0.922 g/cm³, MFR=5 g/10 min), 50 mass parts of high-density polyethylene (density of 0.970 g/cm³, MFR=20 g/10 min), and a thickness of 15 μm were melted-coextruded with a coat hanger die for simultaneously coextruding two-layer, to thereby prepare the backface polyethylene resin layer.

On the other hand, a surface of the raw paper was also subjected to the corona discharge, and the following (1) and (2) were melted-coextruded with the coat hanger die for simultaneously coextruding two-layer: (1) a layer having a thickness of 14 μm, including: (a) 10 mass parts of master batch made by kneading 60 mass parts of TiO₂ and 2.4 mass parts of zinc stearate in 37.6 mass parts of low-density polyethylene (density of 0.920 g/cm³, MFR=5 g/10 min), (b) 4 mass parts of master batch with a blue pigment kneaded therein, and (c) 86 mass parts of low-density polyethylene (density of 0.918 g/cm³, MFR=8 g/min); and (2) an outermost layer having a thickness of 16 μm, including: (a) 33 mass parts of master batch made by kneading 60 mass parts of TiO₂ and 2.4 mass parts of zinc stearate in 37.6 mass parts of low-density polyethylene (density of 0.920 g/cm³, MFR=5 g/10 min), (b) 5 mass parts of master batch with a fluorescent brightening agent kneaded therein, and (c) 4 mass parts of master batch with a blue pigment kneaded therein.

Immediately after the above melting-coextruding, molding was carried out by using a cooling roller whose surface roughness was properly adjusted, to thereby form a surface resin layer having a depression-and-protrusion having a ten point height of roughness profile Rz and an average depression-and-protrusion space Sm which are shown in table 2. Supports of the example 1 to the example 4 and supports of the comparative example 1 to the comparative example 3 were thus prepared.

Herein, Surfcorder SE-3C (made by Kosaka Laboratory Ltd.) was used for measuring the ten point height of roughness profile Rz and the average depression-and-protrusion space Sm, pursuant to JIS B 0601-1994.

TABLE 2

| | No. | | | | | | |
|---|---|---|---|---|---|---|---|
| | 1 | 2 | 3 | 4 | 5 | 6 | 7 |
| Rz (μm) | 0.5 | 1 | 5.5 | 10 | 20 | 25 | 30 |
| Sm (μm) | 10 | 20 | 100 | 400 | 800 | 1000 | 1500 |

-Forming Back Layer-

Under the presence of a reactive emulsifier (Adecaria Soap SE-10N made by Asahi Denka Co., Ltd.) 62 mass parts of styrene as an aromatic ethylene unsaturated monomer, 8 mass parts of acrylic acid as an ethylene unsaturated monomer, and 30 mass parts of acrylic acid 2-ethyl hexyl as another ethylene unsaturated monomer were subjected to an emulsion polymerization, to thereby prepare an aqueous dispersion of styrene-(ester) acrylate.

14 mass parts of the aqueous dispersion of the thus prepared styrene-(ester)acrylate, 4 mass parts of water-soluble high molecular compound made of sodium polystyrene sulfonate (Chemistat SA9 made by Sanyo Chemical Industries, Ltd.), 6 mass parts of colloidal silica, and 20 mass parts of methanol were mixed, added by water, to thereby obtain a total 100 mass parts, thus preparing an aqueous back layer coating solution.

To a backface (non-gloss resin layer) of each of the supports, the thus prepared aqueous back layer coating solution was applied using a wire coater, such that an after-drying thickness of the back layer became 0.25 μm, to thereby prepare the back layer.

-Forming Intermediate Layer-

100 mass parts of water-dispersible acrylic resin (Hiros HE-1335 made by Seiko Chemicals), 2 mass parts of surfactant (Rapisol B-90 made by NOF CORPORATION, solid content of 10% by mass), and 30 mass parts of ion exchange water were mixed, to thereby prepare a composition for the intermediate layer.

The thus prepared composition for the intermediate layer was applied to the surface of each of the supports using a wire coater, such that an after-drying thickness of the intermediate layer became 5 μm.

-Forming Toner Image-Receiving Layer-

100 mass parts of water-dispersible polyester resin (Elitel KZA-1449 made by Unitika Ltd., solid content of 30% by mass, fluidity starting temperature of 100.4° C.), 5 mass parts of releasing agent (camauba wax branded as Cellosol 524 made by Chukyo Yushi Co., Ltd.), 7.5 mass parts of white pigment (TiO₂) water-dispersible solution (TiO₂ (TIPAQUE R780-2 made by Ishihara Sangyo Kaisha, Ltd.) and water-dispersible solution by high molecular dispersing agent), 8 mass parts of surfactant (Rapisol D-337 made by NOF CORPORATION, solid content of 10% by mass), 7 mass parts of charge control agent (Rapisol B-90 made by NOF CORPORATION, solid content of 10% by mass), and a proper amount of ion exchange water were mixed, to thereby prepare a coating solution for the toner image-receiving layer.

The thus prepared coating solution for the toner image-receiving layer was applied to the intermediate layer using a wire coater, such that an after-drying thickness of the toner image-receiving layer became 7 μm, followed by drying at 100° C. for 5 minutes, to thereby prepare an electrophotographic image receiving sheets to be used for the example 1 to the example 4 and the comparative example 1 to the comparative example 3.

<Evaluating Image Recording and Performance>

An image recording apparatus (DCC-500 made by Fuji Xerox Co., Ltd.) was used for printing a black solid image on the electrophotographic image receiving sheets for the example 1 to the example 4 and the comparative example 1 to the comparative example 3. Then, the evaluation was carried out on the toner image face in terms of depression-and-protrusion (Rz, Sm), external view of silk tone, image (gloss), traveling property, adhesion resistance, and fingerprint adhesion, in the following manner. Results are shown in table 3-1 and table 3-2.

(1) Measuring Depression-and-Protrusion (Rz, Sm) of Toner Image face

Surfcorder SE-3C (made by Kosaka Laboratory Ltd.) was used for measuring the ten point height of roughness profile Rz and the average depression-and-protrusion space Sm, pursuant to JIS B 0601-1994.

(2) External View of Silk Tone

An image recording apparatus (DCC-500 made by Fuji Xerox Co., Ltd.) was used for printing a human image, thus carrying out a functional evaluation under a room illumination by the following criteria:

[Evaluation criteria]

| | |
|---|---|
| Excellent: | Calm silk tone with high grade |
| Good: | Considerably high grade |
| Unsatisfactory: | Unsatisfactory |
| Poor: | Rough (grained) or glossiness |

(3) Image Quality (Gloss)

An image recording apparatus (DCC-500 made by Fuji Xerox Co., Ltd.) was used for bring about a squire picture of 10 cm×10 cm with six stepwise densities (0%, 20%, 40%, 60%, 80%, and 100%) under B/W (black and white) condition. A digital variable-angle gloss meter (UGV-5D made by Suga Test Instruments Co., Ltd.) was used for measuring the above six steps pursuant to JIS Z8741 at 20 degree, recording the minimum value. Of the present invention, the 20-degree gloss is preferred to be 75 or more.

(4) Traveling Property

An image recording apparatus (DCC-500 made by Fuji Xerox Co., Ltd.) was used for counting a total of jammed paper sheets and cumulative failure paper sheets of 100 continuously fed paper sheets. Of the present invention, the traveling property is preferred to be two or less.

(5) Adhesion Resistance

The thus obtained electrophotographic prints were prepared under 8% RH or less at 40° C. for 24 hours. The toner image-receiving faces were superimposed with each other, and a load of 500 g was applied to 3.5 cm×3.5 cm of the thus superimposed samples, to be left at rest for seven days under the same environment. The states for peeling the samples were evaluated by the following criteria. Of the present invention, the adhesion resistance is preferably 2 or less.

[Evaluation Criteria]

1. Free from peeling noise or adhesion track

2. A slight peeling noise or a slight adhesion track

3. Adhesion track less than ¼

4. Adhesion track of ¼ to ½

5. Adhesion track or ½ or more

(6) Fingerprint Adhesion

A thumb was pressed on the image face after the image recording. Then, the fingerprint adhesion was evaluated under a room illumination by the following criteria:

[Evaluation Criteria]

Excellent: An excessively small fingerprint adhesion

Good: A small fingerprint adhesion

Unsatisfactory: A considerably strong fingerprint track

Poor: An evident fingerprint track

TABLE 3-1

| | | Example 1 | Example 2 | Example 3 | Example 4 |
|---|---|---|---|---|---|
| Surface | No. (Table 2) | 3 | 4 | 5 | 6 |
| roughness of support | Rz (μm) | 5.5 | 10 | 20 | 25 |
| | Sm (μm) | 100 | 400 | 800 | 1000 |
| Depression-and- | Rz (μm) | 5 | 8 | 17 | 22 |
| protrusion of | Sm (μm) | 100 | 400 | 800 | 1000 |
| image face | | | | | |

| | | | | |
|---|---|---|---|---|
| External view of silk tone | Good | Excellent | Excellent | Good |
| Fingerprint adhesion | Good | Good | Excellent | Excellent |
| Traveling property | 1 | 0 | 0 | 1 |
| Adhesion resistance | 2 | 2 | 2 | 1 |

TABLE 3-2

| | | Comparative | Comparative | Comparative |
|---|---|---|---|---|
| | | example 1 | example 2 | example 3 |
| Surface | No. | 1 | 2 | 7 |
| roughness of | (Table 2) | 0.5 | 1 | 30 |
| support | Rz (μm) | 10 | 20 | 1500 |
| | Sm (μm) | | | |
| Depression-and- | Rz (μm) | 0.3 | 0.8 | 28 |
| protrusion of | Sm (μm) | 10 | 20 | 1500 |
| image face | | | | |

| | | | |
|---|---|---|---|
| External view of silk tone | Poor | Unsatis- | Poor |
| | | factory | |
| Fingerprint adhesion | Poor | Unsatis- | Good |
| | | factory | |
| Traveling property | 4 | 3 | 4 |
| Adhesion resistance | 4 | 3 | 1 |

Each of the depressions-and-protrusions in the example 1 to the example 4, and in the comparative example 1 to the comparative example 3 has a slope inclined from the image face, defining valley-and-peak.

(Example 5 to Example 8, and Comparative Example 4 to Comparative Example 6)

<Preparing Belt Having Surface with Depression-and-Protrusion>

To a belt support made of polyimide resin, a silicone rubber primer (DY39-115 made by Dow Corning Toray Silicone Co., Ltd.) was applied, followed by wind-drying for 30 minutes. Then, a coating film was formed by applying (dipping) a coating solution which was prepared by 100 mass parts of silicone rubber precursor (DY35-796AB made by Dow Corning Toray Silicone Co., Ltd.) and 30 mass parts of n-hexane, followed by a primary curing at 120° C. for 10 minutes, to thereby form a silicone rubber layer having thickness of 40 μm.

On the thus formed silicone rubber layer, a coating film was formed by applying (dipping) a coating solution which was prepared by 100 mass parts of fluorocarbon siloxane rubber precursor (SIFEL610 made by Shin-Etsu Chemical Co., Ltd.) and 20 mass parts of fluorine solvent (a mixed solvent of: m-xylene hexa fluoride, perfluoroalkane, and perfluoro (2-butyl tetra hydrofuran)), followed by pressing a molding member which was formed, through a sand blast method with specific single-dispersion particles, with a specific irregular structure (rough face) on a metal face (iron), to thereby transfer the mold. Then, a primary curing was carried out at 120° C. for 10 minutes, and a secondary curing was carried out at 180° C. for 4 hours, to thereby prepare a belt having the fluorocarbon cyclohexane rubber layer having thickness of 20 μm. Preparing the conditions of the sand blast method with the specific single-dispersion particle can form, on the surface of the belt, the ten point height of roughness profile Rz and the average depression-and-protrusion space Sm shown in table 4.

The ten point height of roughness profile Rz and the average depression-and-protrusion space Sm were measured based on JIS B 0601-1994 using Surfcorder SE-3C (made by Kosaka Laboratory Ltd.).

TABLE 4

| | Belt name | | | | | | |
|---|---|---|---|---|---|---|---|
| | a | b | c | d | e | f | g |
| Rz (μm) | 0.5 | 1 | 5 | 10 | 20 | 25 | 30 |
| Sm (μm) | 10 | 20 | 100 | 400 | 800 | 1000 | 1500 |

<Evaluating Image Recording and Performance>

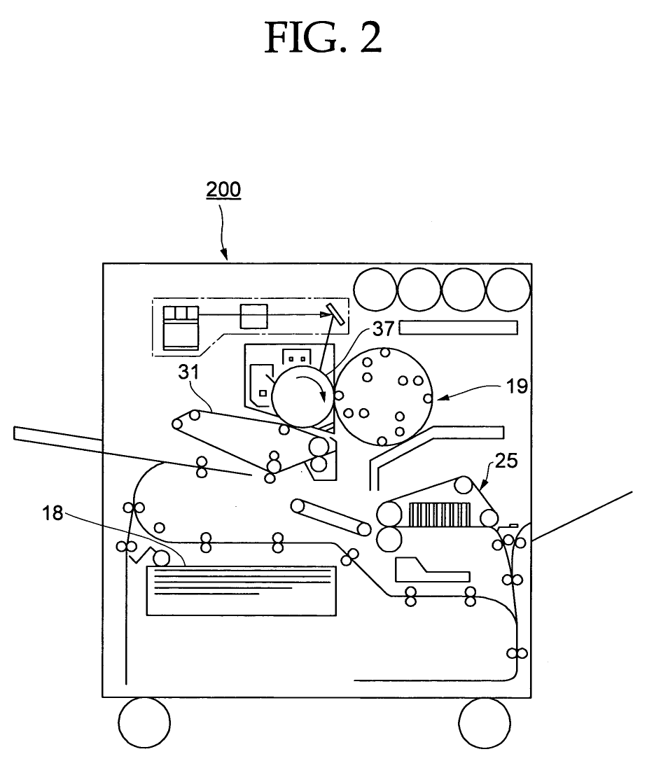

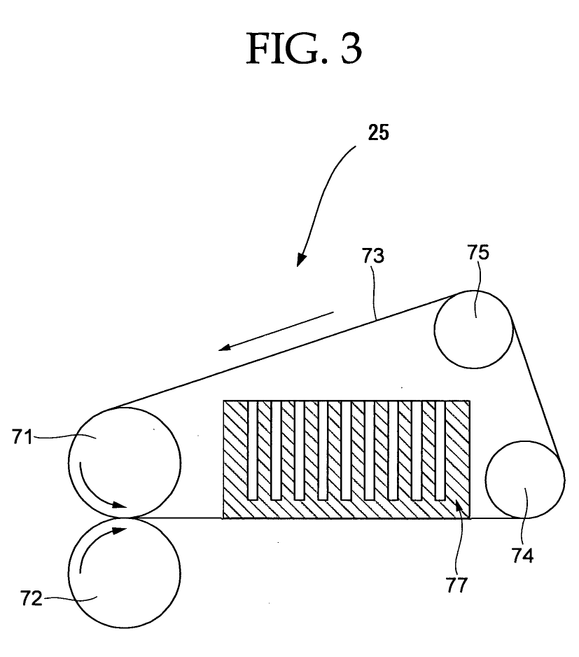

An image recording apparatus (DocuCentre Color-500CP made by Fuji Xerox Co., Ltd.) shown in FIG. 2 was modified into an image surface smoothing-fixing apparatus in FIG. 3 for printing a black solid image on the electrophotographic image receiving sheets. Then, with the combinations shown in table 5, table 6-1 and table 6-2, a roughness treatment was carried out.

With reference to FIG. 2, the image forming apparatus 200 includes photoconductive drum 37, development device 19, intermediate transfer belt 31, electrophotographic material 18, and fixing unit 25 (smoothing and fixing unit for image surface).

FIG. 3 shows fixing device 25 (smoothing and fixing unit for image surface) to be arranged inside the image forming apparatus 200 of FIG. 2.

As shown in FIG. 3, the smoothing and fixing unit for image surface 25 comprises heat roller 71, peeling roller 74, tension roller 75, endless belt 73 supported rotatably by heat roller 71, and pressure roller 72 pressing the heat roller 71 through endless belt 73.

Cooling heatsink 77, which forces endless belt 73 to cool, is arranged inside the endless belt 73 between heat roller 71 and peeling roller 74. The cooling heatsink 77 constitutes the cooling and sheet-conveying unit for cooling and conveying the electrophotographic material.

In smoothing and fixing unit for image surface 25 as shown in FIG. 3, an electrophotographic-transferring sheet, bearing a transferred and fixed color toner image on its surface, is introduced into a pressing portion (or nip portion), between heat roll 71 and pressure roll 72 that presses heat roll 71 through endless belt 73, so that the color toner image faces heat roller 71. The color toner image is heated, fused and thereby fixed on the electrophotographic material while the electrophotographic material passes through the pressing portion between the heat roller 71 and the pressure roller 72.

Thereafter, the toner is heated to about 120° C. to 130° C. at the pressing portion between heat roller 71 and pressure roller 72 and is thereby fused and fixed to the image-receiving layer of the electrophotographic material. The electrophotographic material with the color toner image fixed on its image-receiving layer is then conveyed with the endless belt 73 while its surface image-receiving layer is in intimate contact with the surface of endless belt 73. During conveying, endless belt 73 is forcedly cooled by the cooling heatsink 77 to thereby cool and solidify the color toner image and the image-receiving layer, and the electrophotographic material is then peeled or separated from the endless belt 73 due to its own rigidity or stiffness with the action of peeling roller 74.

Then, like the example 1 to the example 4 and the comparative example 1 to the comparative example 3, the electrophotographic prints of the example 5 to the example 8 and the comparative example 4 to the comparative example 6, respectively, were subjected to the evaluation. The evaluation was carried out on the toner image face in terms of depression-and-protrusion (Rz, Sm), external view of silk tone, image (gloss), traveling property, adhesion resistance, fingerprint adhesion. Results are shown in table 6-1 and table 6-2.

TABLE 5

| Temperature | | | |
|---|---|---|---|
| conditions | A | B | C |
| Nip temperature | 125 | 95 | 125 |
| (° C.) | | | |
| Peeling | 75 | 75 | 115 |
| temperature (° C.) | | | |

TABLE 6-1

| | | Example 5 | Example 6 | Example 7 | Example 8 |
|---|---|---|---|---|---|
| Belt name | | c | d | e | f |
| Surface | Rz (μm) | 5 | 10 | 20 | 25 |
| roughness of | Sm (μm) | 100 | 400 | 800 | 1000 |
| belt | | | | | |
| Temperature condition | | A | A | A | A |
| for forming | | | | | |
| depression-and-protrusion | | | | | |
| (see table 5) | | | | | |
| Depression-and-protrusion | Rz (μm) | 5 | 10 | 20 | 25 |
| of image face | Sm (μm) | 100 | 400 | 800 | 1000 |

| | | | | |
|---|---|---|---|---|
| External view of silk tone | Good | Excellent | Excellent | Good |
| Fingerprint adhesion | Good | Good | Excellent | Excellent |
| Traveling property | 1 | 0 | 0 | 1 |
| Adhesion resistance | 2 | 2 | 2 | 1 |

TABLE 6-2

| | | Comparative | Comparative | Comparative |
|---|---|---|---|---|
| | | example 4 | example 5 | example 6 |
| Belt name | | a | b | g |
| Surface | Rz (μm) | 0.5 | 1 | 30 |
| roughness of | Sm (μm) | 10 | 20 | 1500 |
| belt | | | | |
| Temperature condition | | A | B | C |
| for forming | | | | |
| depression-and-protrusion | | | | |
| (see table 5) | | | | |
| Depression-and- | Rz (μm) | 0.5 | 1 | 30 |
| protrusion of | Sm (μm) | 10 | 20 | 1500 |
| image face | | | | |

| | | | |
|---|---|---|---|
| External view of silk tone | Poor | Unsatis- | Poor |
| | | factory | |
| Fingerprint adhesion | Poor | Unsatis- | Good |
| | | factory | |
| Traveling property | 3 | 3 | 4 |
| Adhesion resistance | 4 | 3 | 1 |

Each of the depressions-and-protrusions in the example 5 to the example 8, and in the comparative example 4 to the comparative example 6 has a slope inclined from the image face, defining valley-and-peak.

The image recording material of the present invention has a calm image quality in a silk tone having as high grade as that of a silver salt photographic print. Moreover, the image recording material of the present invention can go unremarkable even with a fingerprint adhered to an image face after the image recording. The image recording material of the present invention is especially preferable for a large print, specifically, used as various recording materials including the electrophotographic image-receiving sheet, the melted heat transferring-recording sheet, the sublimational heat transferring-recording sheet, the heat sensitive recording sheet, and the ink jet recording sheet.

On the image face of the image recording material after image recording, the depression-and-protrusion forming method of the present invention can effectively form a depression-and-protrusion defining a slope inclined from the image face, where the depression-and-protrusion of the image face has the ten point height of roughness profile Rz in a range from 5 μm to 25 μm and has the average depression-and-protrusion space Sm in a range from 100 μm to 1000 μm.

1. An image recording material, comprising:
a support; and
an image recording layer disposed on the support, and having a depression-and-protrusion at least on a part of an image face of the image recording material after an image recording, the depression-and-protrusion defining a slope inclined from the image face,
wherein the depression-and-protrusion of the image face has a ten point height of roughness profile Rz defined in JIS B0601-1994 in a range from 5 μm to 25 μm and has an average depression-and-protrusion space Sm defined in JIS B0601-1994 in a range from 100 μm to 1000 μm.

2. The image recording material according to claim 1, wherein the image face has the ten point height of roughness profile Rz defined in JIS B0601-1994 in a range from 5 μm to 20 μm and the depression-and-protrusion has the average depression-and-protrusion space Sm defined in JIS B0601-1994 in a range from 150 μm to 800 μm.

3. The image recording material according to claim 1, wherein the support comprises:
raw paper, and
a polyolefine resin layer on the raw paper's face to be formed with the image recording layer.

4. The image recording material according to claim 3, wherein the polyolefine resin layer has a surface having a ten point height of roughness profile Rz in a range from 5 μm to 25 μm and a depression-and-protrusion having an average depression-and-protrusion space Sm in a range from 100 μm to 1000 μm.

5. The image recording material according to claim 4, wherein the polyolefine resin layer has a thickness in a range from 10 μm to 50 μm.

6. The image recording material according to claim 1, wherein the image recording material is at least one selected from the group consisting of an electrophotographic image-receiving sheet, a melted heat transferring-recording sheet, a sublimational heat transferring-recording sheet, a heat sensitive recording sheet, and an ink jet recording sheet.

7. The image recording material according to claim 6, wherein
the image recording material is the electrophotographic image-receiving sheet, and
the electrophotographic image-receiving sheet comprises the support and at least one layer of a toner image-receiving layer disposed on the support.

8. The image recording material according to claim 7, wherein the support comprises:
raw paper, and
a polyolefine resin layer on the raw paper's face to be formed with the toner-image-receiving layer.

9. The image recording material according to claim 8, wherein the polyolefine resin layer has a surface having a ten point height of roughness profile Rz defined in JIS B0601-1994 in a range from 5 μm to 25 μm and a depression-and-protrusion having an average depression-and-protrusion space Sm defined in JIS B0601-1994 in a range from 100 μm to 1000 μm.

10. The image recording material according to claim 7, wherein
a content of a releasing agent in the toner image-receiving layer is from 1% by mass to 20% by mass, and
a content of a releasing agent in a toner received in the toner image-receiving layer is from 1% by mass to 20% by mass.

11. The image recording material according to claim 7, wherein a total thickness of the toner image-receiving layer is 2 μm or more.

12. A depression-and-protrusion forming method, comprising:
heating at least a part of an image face of an image recording material after an image recording; and
transferring to the thus heated image face a depression-and-protrusion by pressing to the heated image face a molding member having a surface formed with the depression-and-protrusion, the depression-and-protrusion defining a slope inclined from the image face,
wherein the depression-and-protrusion has a ten point height of roughness profile Rz defined in JIS B0601-1994 in a range from 5 μm to 25 μm and has an average depression-and-protrusion space Sm defined in JIS B0601-1994 in a range from 100 μm to 1000 μm.

13. The depression-and-protrusion forming method according to claim 12, further comprising cooling and peeling the image recording material to which the depression-and-protrusion is transferred.

14. The depression-and-protrusion forming method according to claim 12, wherein a heating temperature in the heating is a fluidity starting temperature or more of a thermoplastic resin of the image face of the image recording material.

15. The depression-and-protrusion forming method according to claim 14, wherein
the image recording material is an electrophotographic image-receiving sheet comprising a toner image-receiving layer, and
the heating temperature in the heating is at least one of the following:
i) a fluidity starting temperature or more of a thermoplastic resin of the toner image-receiving layer, and
ii) a fluidity starting temperature or more of a binder of a toner received in the toner image-receiving layer.

16. The depression-and-protrusion forming method according to claim 13, wherein a cooling temperature in the cooling is less than a fluidity starting temperature of a thermoplastic resin of the image face of the image recording material.

17. The depression-and-protrusion forming method according to claim 16, wherein
the image recording material is an electrophotographic image-receiving sheet comprising a toner image-receiving layer, and
the cooling temperature in the cooling is at least one of the following:
i) less than a fluidity starting temperature of a thermoplastic resin of the toner image-receiving layer, and
ii) less than a fluidity starting temperature of a binder of a toner received in the toner image-receiving layer.

18. The depression-and-protrusion forming method according to claim 12, wherein the molding member is at least one selected from the group consisting of a belt, a stamper, and a roller.

19. The depression-and-protrusion forming method according to claim 18, wherein the belt is an endless flexible belt.

20. A depression-and-protrusion forming method, comprising:
disposing an image recording layer on a support, the support's side to be formed with the image recording layer having a first depression-and-protrusion which has a ten point height of roughness profile Rz defined in JIS B0601-1994 in a range from 5 μm to 25 μm and has an average depression-and-protrusion space defined in JIS B0601-1994 Sm in a range from 100 μm to 1000 μm; and
recording an image on the image recording layer, to thereby form on an image face of the image recording layer a second depression-and-protrusion defining a slope inclined from the image face,
wherein the second depression-and-protrusion of the image face has a ten point height of roughness profile Rz defined in JIS B0601-1994 in a range from 5 μm to 25 μm and has an average depression-and-protrusion space Sm defined in JIS B0601-1994 in a range from 100 μm to 1000 μm.

21. The image recording material according to claim 20, wherein the support comprises:
raw paper, and a polyolefine resin layer on the raw paper's face to be formed with the image recording layer.
